(19) United States
(12) Patent Application Publication
(10) Pub. No.: US 2004/0093504 A1
(43) Pub. Date: May 13, 2004

(54) Information processing apparatus, method, system, and computer program product

(75) Inventor: Toshikazu Ishizaki, Tokyo (JP)

Correspondence Address: VENABLE, BAETJER, HOWARD AND CIVILETTI, LLP, P.O. BOX 34385, WASHINGTON, DC, 20043-9998, US

(73) Assignee: Toshikazu ISHIZAKI, Tokyo (JP)

(21) Appl. No.: 10/614,289

(22) Filed: Jul. 8, 2003

(30) Foreign Application Priority Data
Nov. 13, 2002 (JP) 2002-329468

(51) Int. Cl. H04L 9/32

(52) U.S. Cl. 713/189; 713/201

(57) ABSTRACT

Herein disclosed is an information processing apparatus for processing a plurality of entry information elements transmitted from at least one terminal, comprising: period setting means for setting an output operation period after specifying an output start time and an output end time collectively defining the output operation period; time keeping means for keeping time including the output start time specified by the period setting means and the output end time specified by the period setting means; information receiving means for receiving the entry information elements transmitted from the terminal; information encrypting means for encrypting the entry information elements received from the information receiving means before producing encrypted entry information elements; information storing means for storing the encrypted entry information elements produced by the information encrypting means; and information decrypting means for decrypting the encrypted entry information elements stored in the information storing means during the output operation period starting from the output start time kept by the time keeping means until the output end time kept by the time keeping means wherein the output operation period is kept secret.

### BACKGROUND OF THE INVENTION

1. Field of the Invention

The present invention relates to an information processing apparatus, an information processing method, an information processing system, and an information processing computer program product, and more particularly to an information processing apparatus for, an information processing method of, an information processing system for, and a computer program product for encrypting and decrypting information in a specified time period.

2. Description of the Related Art

An election is crucial to a democratic society since the outcome of the election will directly affect the political system governing the society. Well in advance of an election such as for example a parliamentary general election, a gubernatorial election, and a municipal election, each of qualified electors is respectively delivered a poll card. On the election day, the electors go to their polling stations in respective constituencies, and receive their ballot papers in exchange for the poll cards. The electors are requested to complete the ballot papers in secret in cubicles and put them in ballot boxes in the polling stations. At the closing of the polls, the ballot boxes are sealed and transported to a counting centre where the ballot boxes are unsealed and the numbers of ballots cast for candidates and/or parties are manually counted by personnel. This conventional voting system entails a disadvantage that the numbers of ballots are required to be counted by personnel in the counting centers, thereby consuming enormous time and costs.

Up until now, there have been proposed a wide variety of electronic voting systems in order to overcome the above disadvantage. One typical example of the conventional electronic voting system is disclosed in Japanese patent laid-open publication No. 2002-140460. The conventional electronic voting system is shown in FIG. 13 as comprising a plurality of electronic poll cards 12 each composed of an IC card having stored therein ID information 13 for identifying one of the qualified electors, a plurality of voting terminals 15 for reading each of the electronic poll cards 12, detecting the ID information 13 contained in each of the electronic poll cards 12, having each of the qualified electors input therein his or her vote, hereinlater referred to as “voting information element”, and transmitting a voting signal indicative of the voting information element 11 and the ID information 13, electronic ballot boxes 17 connected with the voting terminals 15 in respective constituencies through a public internet network 16, each for receiving the voting signals inputted by the electors and the ID information 13 from the voting terminals 15 in the constituency, identifying each of the qualified electors on the basis of each of the ID information 13 received from the voting terminals 15, and store the voting signals when the qualified electors are identified with the ID information 13, counting the number of votes for each candidate and/or party on the basis of the voting signals thus stored, and transmitting a result signal indicative of the number of votes counted for each candidate and/or party, hereinlater referred to as “voting result information” in the constituency, and a counting centre 19, connected with the electronic ballot boxes 17 through a public internet network 20 for receiving the result signals from the electronic ballot boxes 17 and storing therein the result signal thus received, and counting the total number of votes for each candidate and/or party, hereinlater referred to as “total voting result information” on the basis of the result signals thus received from the electronic ballot boxes 17 and stored therein.

Operation of the conventional electronic voting system will be described hereinlater.

Each of the qualified electors inserts his or her electronic poll card 12 into the voting terminal 15. The voting terminal 15 is operated to obtain the ID information 13 from the electronic poll card 12, and have the elector input his or her voting information element 11 therein. The voting terminal 15 is then operated to transmit the ID information 13 and a voting signal indicative of the voting information element 11. Each of the electronic ballot boxes 17 is operated to receive the ID information 13 and the voting signal from the voting terminals 15 in the constituency. The electronic ballot box 17 is operated to identify each of the electors on the basis of each of the ID information 13 thus received, and store therein each of the voting signals when the elector is identified with the ID information 13. The electronic ballot box 17 is then operated to electronically count the number of votes for each candidate and/or party in accordance with the voting signals thus received from the voting terminals 15, and stored therein, and transmit the result signal indicative of the voting result information. The counting centre 19 is operated to receive and store the result signals transmitted from the electronic ballot boxes 17, and count the total number of votes for each candidate and/or party on the basis of the result signals thus received from the electronic ballot boxes 17 and stored therein.

Another example of the conventional electronic voting system disclosed in the Japanese patent laid-open publication No. 2002-032516 is operable to encrypt the voting information elements 11 in a manner of an encrypting and decrypting method using a public key and a secret key before transmitting the voting signals respectively indicative of the voting information elements 11 to the electronic ballot boxes 17 in order to prevent the voting information elements 11 from being tapped and falsified by third parties while being transmitted. According to the conventional voting system disclosed in the Japanese patent laid-open publication No. 2002-032516, the IC card of each of the electronic poll cards 12 further has the public key stored therein, and each of the electronic ballot boxes 17 has the secret key corresponding to the public key. The voting terminal 15 may be operated to encrypt each of the voting information elements 11 with the public key stored in each of the electronic poll cards 12 before transmitting the voting signal to the electronic ballot boxes 17, and each of the electronic ballot boxes 17 is operated to receive the voting signals respectively indicative of the encrypted voting information elements 14 from the voting terminals 15, store therein the voting signals thus received, and electronically count the number of votes for each candidate and/or party in accordance with the voting signals after decrypting the encrypted voting information element 14 with the secret key.

Another example of the conventional electronic voting system disclosed in the Japanese patent laid-open publication No. 2000-269957 is operable to encrypt the results of votes calculated by the electronic ballot boxes 17 in a manner of an encrypting and decrypting method using a public key and a secret key before transmitting the result signal indicative of the result of the votes thus calculated to the electronic counting centre in order to prevent the voting result information from being tapped and falsified by third parties while being transmitted. According to the conventional voting system disclosed in the Japanese patent laid-open publication No. 2002-269957, each of the electronic ballot boxes 17 has the public key and the counting centre 19 has the secret key. Each of the electronic ballot boxes 17 may be operated to encrypt the voting result information with the public key before transmitting the result signal indicative of voting result information to the counting centre 19, and the counting centre 19 may be operated to receive the result signal from the electronic ballot boxes 17, store therein the result signal after decrypting the encrypted total voting result information with the secret key, and count total voting result information on the basis of the result signals stored therein.

The conventional electronic voting system thus constructed as previously mentioned, however, encounters a drawback that the voting signals respectively indicative of voting information elements 11 stored in the electronic ballot boxes 17 and the result signals respectively indicative of the voting result information stored in the counting centre 19 are not encrypted, thereby making it possible for third parties to tap or falsify the voting information elements 11 stored in the electronic ballot boxes 17 or the voting result information stored in the counting centre 19 if the third parties should succeed in unauthorized access to the electronic ballot boxes 17 or the counting centre 19.

Further, the conventional electronic voting system, in which the electronic ballot boxes 17 are operative to transmit the result signals respectively indicative of the encrypted voting result information to the counting centre 19 after encrypting the voting result information with the same public key, encounters another drawback that the result signals transmitted from the plurality of electronic ballot boxes 17 contain the same encryption information, thereby enabling third parties to crack the encryption information by collecting the encryption information from the result signals being transmitted from the electronic ballot boxes 17, and decrypt the encrypted voting result information 14. The conventional electronic voting system thus constructed cannot protect privacy of the electors.

Each of the electronic ballot boxes 17, on the other hand, may be operative to encrypt the voting result information with, for example, a unique public key before transmitting the result signal indicative of voting result information to the counting centre 19 with the result that the result signals transmitted from the plurality of electronic ballot boxes 17 will contain encryption information different from one another. The conventional electronic voting system thus constructed, however, encounters another drawback that the counting centre 19 is required to decrypt the voting result information transmitted from the electronic ballot boxes 17 with a plurality of secret keys each dedicated to one of the electronic ballot boxes 17, thereby causing the conventional electronic voting system to be complicated and inefficient.

Furthermore, computers constituting the electronic ballot boxes 17 and the counting centre 19 have respective internal clocks each keeping time including a voting start time when the electronic ballot boxes 17 are operative to start receiving the voting information elements 11 from the voting terminals 15, and a voting end time when the electronic ballot boxes 17 are operative to stop receiving the voting information elements 11 from the voting terminals 15. The counting centre 19 is operative to start receiving and storing the result signal from the electronic ballot boxes 17, and counting the total voting result information at the same voting start time or later than the same voting start time. The conventional electronic voting system constructed as previously mentioned encounters another drawback that the internal clocks forming part of the electronic ballot boxes 17 and the counting centre 19 are separately adjusted, thereby making it difficult for the internal clocks forming part of the electronic ballot boxes 17 and the counting centre 19 to be accurately synchronized to one another. The fact that the internal clocks forming part of the electronic ballot boxes 17 and the counting centre 19 fail to be accurately synchronized to one another leads to the fact that the poll hours differ from one constituency to another, thereby unable to realize a fair and impartial election.

### SUMMARY OF THE INVENTION

It is, therefore, an object of the present invention to provide an information processing apparatus, an information processing method, an information processing system, and an information processing computer program product, in which the voting information elements stored in a data storing device are not decrypted until a predetermined output start time at which the number of votes are counted on the basis of the voting information elements stored in the data storage means, making it impossible for anyone including third party and internal personnel to tap or falsify the voting information elements, thereby ensuring a protection of privacy and realizing a fair and impartial election.

It is another object of the present invention to provide an information processing apparatus, an information processing method, an information processing system, and an information processing computer program product, in which internal clocks forming part of constituents elements of the information processing apparatus can be accurately synchronized to one another, thereby enabling to realize a fair and impartial election.

It is a further object of the present invention to provide an information processing apparatus, an information processing method, an information processing system, and an information processing computer program product, in which entry information elements are encrypted, transmitted, and decrypted in a specified secret operation time period, preventing anyone including third party and internal personnel from collecting the encryption information from the entry information elements while being transmitted, thereby making it impossible for third parties to crack the encryption information and decrypt the encrypted entry information elements, and protecting privacy of electors.

In accordance with a first aspect of the present invention, there is provided an information processing apparatus for processing a plurality of entry information elements transmitted from at least one terminal, comprising: period setting means for setting an output operation period after specifying an output start time and an output end time collectively defining the output operation period; time keeping means for keeping time including the output start time specified by the period setting means and the output end time specified by the period setting means; information receiving means for receiving the entry information elements transmitted from the terminal; information encrypting means for encrypting the entry information elements received from the information receiving means before producing encrypted entry information elements; information storing means for storing the encrypted entry information elements produced by the information encrypting means; and information decrypting means for decrypting the encrypted entry information elements stored in the information storing means during the output operation period starting from the output start time kept by the time keeping means until the output end time kept by the time keeping means.

In the aforementioned information processing apparatus, time obtaining means for obtaining standard time information indicative of standard time kept by a standard clock; and time adjusting means for adjusting the time keeping means to have the time keeping means synchronized to the standard time on the basis of the standard time information obtained by the time obtaining means. The time obtaining means may further include a standard time receiver for receiving the standard time information transmitted from a standard time transmitter at a predetermined frequency. The standard time receiver may be of a waterproof and heat resistant construction.

The aforementioned information processing apparatus may further comprise: error storing means for storing error information indicative of an error of the time kept by the time keeping means with respect to the standard time on the bass of the standard time information obtained by the time obtaining means. The aforementioned information processing apparatus may further comprise: position obtaining means for obtaining position information indicative of a position thereof, in which the time adjusting means is operative to adjust the time keeping means to have the time keeping means synchronized to the standard time on the basis of the position information obtained by the position obtaining means.

In the aforementioned information processing apparatus, the time obtaining means may be placed in a first time zone while the terminal is placed in a second time zone different from the first time zone, the period setting means, the information receiving means, and the information storing means have respective internal clocks, the time adjusting means is operative to calculate alternative standard time in accordance with the standard time information obtained by the time obtaining means in consideration of a time difference between the first time zone where the time obtaining means is operative to obtain the standard time information indicative of standard time, and the second time zone where the terminal is placed, and adjust each of the internal clocks forming part of the period setting means, the information receiving means, and the information storing means to have each of the period setting means, the information receiving means, and the information storing means synchronized to the alternative standard time thus calculated.

The period setting means may be operative to set an input operation period after specifying an input start time and an input end time collectively defining the input operation period, and the time keeping means is operative to keep time including the input start time specified by the period setting means and the input end time specified by the period setting means, and the information receiving means is operative to receive the entry information elements transmitted from the terminal during the input operation period starting from the input start time kept by the time keeping means until the input end time kept by the time keeping means.

The aforementioned information processing apparatus may further comprise: instruction accepting means for accepting an output instruction from the terminal, and the information decrypting means may be operative to decrypt the encrypted entry information elements stored in the information storing means in response to the output instruction accepted by the instruction accepting means during the output operation period starting from the output start time kept by the time keeping means until the output end time kept by the time keeping means. Each of the entry information elements may be indicative of voting information elements. Each of the entry information elements may be indicative of biding information elements.

In accordance with a second aspect of the present invention, there is provided an information processing system comprising a plurality of information processing apparatuses for processing a plurality of entry information elements transmitted from at least one terminal, the information processing apparatuses each comprising: period setting means for setting an output operation period after specifying an output start time and an output end time collectively defining the output operation period; time keeping means for keeping time including the output start time specified by the period setting means and the output end time specified by the period setting means; information receiving means for receiving the entry information elements transmitted from the terminal; information encrypting means for encrypting the entry information elements received from the information receiving means before producing encrypted entry information elements; information storing means for storing the encrypted entry information elements produced by the information encrypting means; information decrypting means for decrypting the encrypted entry information elements stored in the information storing means during the output operation period starting from the output start time kept by the time keeping means until the output end time kept by the time keeping means; time obtaining means for obtaining standard time information indicative of standard time kept by a standard clock; and time adjusting means for adjusting the time keeping means to have the time keeping means synchronized to the standard time on the basis of the standard time information obtained by the time obtaining means; whereby the time obtaining means of each of the information processing apparatuses is operative to obtain the standard time information indicative of standard time kept by the standard clock to ensure that the time keeping means of each of the information processing apparatuses is synchronized to the standard time on the basis of the standard time information obtained by the time obtaining means.

In accordance with a third aspect of the present invention, there is provided an information processing method of processing a plurality of entry information elements transmitted from at least one terminal, comprising the steps of: (a) setting an output operation period after specifying an output start time and an output end time collectively defining the output operation period; (b) keeping time including the output start time specified in the step (a) and the output end time specified in the step (a); (c) receiving the entry information elements transmitted from the terminal; (d) encrypting the entry information elements received in the step (c) before producing encrypted entry information elements; (e) storing the encrypted entry information elements produced in the step (d) in a predetermined storage portion; and (f) decrypting the encrypted entry information elements stored in the step (e) during the output operation period starting from the output start time kept in the step (b) until the output end time kept in the step (b).

The aforementioned information processing method may further comprise the steps of: (g) obtaining standard time information indicative of standard time kept by a standard clock; and (h) adjusting the step (b) to have the time kept in the step (b) synchronized to the standard time on the basis of the standard time information obtained in the step (g). The step (g) may have the step of having a standard time receiver receive the standard time information transmitted from a standard time transmitter at a predetermined frequency. The aforementioned standard time receiver may be of a waterproof and heat resistant construction.

The aforementioned information processing method may further comprise the step of: (i) storing error information indicative of an error of the time kept in the step (b) with respect to the standard time on the bass of the standard time information obtained in the step (g). The aforementioned information processing method may further comprise the step of: (j) obtaining position information indicative of a position thereof. The step (h) may have the step of adjusting the step (b) to have the time kept in the step (b) synchronized to the standard time on the basis of the position information obtained in the step (j).

The standard clock may be placed in a first time zone while the terminal is placed in a second time zone different from the first time zone. The step (a), the step (c), and the step (e) are performed in accordance with respective internal clocks, the step (h) has the step of calculating alternative standard time in accordance with the standard time information obtained in the step (g) in consideration of a time difference between the first time zone where the standard clock is placed and the second time zone where the terminal is placed, and adjusting each of the internal clocks to have each of the step (a), the step (c), and the step (e) performed in synchronization with the alternative standard time thus calculated.

The aforementioned step (a) may have the step of (a1) setting an input operation period after specifying an input start time and an input end time collectively defining the input operation period, and the step (b) has the step of keeping time including the input start time specified in the step (a1) and the input end time specified in the step (a1), and the step (c) has the step of receiving the entry information elements transmitted from the terminal during the input operation period starting from the input start time kept in the step (b) until the input end time kept in the step (b).

The aforementioned information processing method may further comprise the step of: (k) accepting an output instruction from the terminal, and the step (f) may have the step of decrypting the encrypted entry information elements stored in the step (e) in response to the output instruction accepted in the step (k) during the output operation period starting from the output start time kept in the step (b) until the output end time kept in the step (b). Each of the entry information elements may be indicative of voting information elements. Each of the entry information elements may be indicative of biding information elements.

In accordance with a fourth aspect of the present invention, there is provided an information processing method of processing a plurality of entry information elements transmitted from at least one terminal, comprising: a preparing step of preparing a plurality of a plurality of information processing apparatuses, each of the information processing apparatuses comprising: period setting means for setting an output operation period after specifying an output start time and an output end time collectively defining the output operation period; time keeping means for keeping time including the output start time specified by the period setting means and the output end time specified by the period setting means; information receiving means for receiving the entry information elements transmitted from the terminal; information encrypting means for encrypting the entry information elements received from the information receiving means before producing encrypted entry information elements; information storing means for storing the encrypted entry information elements produced by the information encrypting means; information decrypting means for decrypting the encrypted entry information elements stored in the information storing means during the output operation period starting from the output start time kept by the time keeping means until the output end time kept by the time keeping means; time obtaining means for obtaining standard time information indicative of standard time kept by a standard clock; and time adjusting means for adjusting the time keeping means to have the time keeping means synchronized to the standard time on the basis of the standard time information obtained by the time obtaining means, and a time obtaining step of having the time obtaining means of each of the information processing apparatuses obtain the standard time information indicative of standard time kept by the standard clock to ensure that the time keeping means of each of the information processing apparatuses is synchronized to the standard time on the basis of the standard time information obtained by the time obtaining means.

In accordance with a fifth aspect of the present invention, there is provided an information processing computer program product comprising a computer usable storage medium having computer readable code embodied therein for processing a plurality of entry information elements transmitted from at least one terminal, wherein the computer readable code comprising: a first program product code for setting an output operation period after specifying an output start time and an output end time collectively defining the output operation period; a second program product code for keeping time including the output start time specified by the first program product code and the output end time specified by the first program product code; a third program product code for receiving the entry information elements transmitted from the terminal; a fourth program product code for encrypting the entry information elements received by the third program product code before producing encrypted entry information elements; a fifth program product code for storing the encrypted entry information elements produced by the fourth program product code in a predetermined storage portion; and a sixth program product code for decrypting the encrypted entry information elements stored by the fifth program product code during the output operation period starting from the output start time kept by the second program product code until the output end time kept by the second program product code.

The aforementioned information processing computer program product may further comprise: a seventh program product code for obtaining standard time information indicative of standard time kept by a standard clock; and an eighth program product code for adjusting the second program product code to have the time kept by the second program product code synchronized to the standard time on the basis of the standard time information obtained by the seventh program product code. The seventh program product code may have a program product code for having a standard time receiver receive the standard time information transmitted from a standard time transmitter at a predetermined frequency. The aforementioned standard time receiver may be of a waterproof and heat resistant construction.

The aforementioned information processing computer program product may further comprise a ninth program product code for storing error information indicative of an error of the time kept by the second program product code with respect to the standard time on the bass of the standard time information obtained by the seventh program product code.

The aforementioned information processing computer program product may further comprise: a tenth program product code for obtaining position information indicative of a position thereof, in which the eighth program product code has a program product code for adjusting the second program product code to have the time kept by the second program product code synchronized to the standard time on the basis of the position information obtained by the tenth program product code.

The aforementioned standard clock may be placed in a first time zone while the terminal is placed in a second time zone different from the first time zone, the first program product code, the third program product code, and the fifth program product code are performed in accordance with respective internal clocks, the eighth program product code has a program product code for calculating alternative standard time in accordance with the standard time information obtained by the seventh program product code in consideration of a time difference between the first time zone where the standard clock is placed and the second time zone where the terminal is placed, and adjusting each of the internal clocks to have each of the first program product code, the third program product code, and the fifth program product code performed in synchronization with the alternative standard time thus calculated.

The first program product code may have a twelfth program product code for setting an input operation period after specifying an input start time and an input end time collectively defining the input operation period, and the second program product code has a program product code for keeping time including the input start time specified by the twelfth program product code and the input end time specified by the twelfth program product code, and the third program product code has a program product code for receiving the entry information elements transmitted from the terminal during the input operation period starting from the input start time kept by the second program product code until the input end time kept by the second program product code. The aforementioned information processing computer program product may further comprises: an eleventh program product code for accepting an output instruction from the terminal, and the sixth program product code has a program product code for decrypting the encrypted entry information elements stored by the fifth program product code in response to the output instruction accepted by the eleventh program product code during the output operation period starting from the output start time kept by the second program product code until the output end time kept by the second program product code. Each of the entry information elements may be indicative of voting information elements. Each of the entry information elements may be indicative of biding information elements.

In accordance with a sixth aspect of the present invention, there is provided an information processing computer program product comprising a computer usable storage medium having computer readable code embodied therein for processing a plurality of entry information elements transmitted from at least one terminal, wherein the computer readable code comprising: a fifteenth program product code for operating a plurality of a plurality of information processing apparatuses, each of the information processing apparatuses comprising: period setting means for setting an output operation period after specifying an output start time and an output end time collectively defining the output operation period; time keeping means for keeping time including the output start time specified by the period setting means and the output end time specified by the period setting means; information receiving means for receiving the entry information elements transmitted from the terminal; information encrypting means for encrypting the entry information elements received from the information receiving means before producing encrypted entry information elements; information storing means for storing the encrypted entry information elements produced by the information encrypting means; information decrypting means for decrypting the encrypted entry information elements stored in the information storing means during the output operation period starting from the output start time kept by the time keeping means until the output end time kept by the time keeping means; time obtaining means for obtaining standard time information indicative of standard time kept by a standard clock; and time adjusting means for adjusting the time keeping means to have the time keeping means synchronized to the standard time on the basis of the standard time information obtained by the time obtaining means, and a sixteenth program product code for having the time obtaining means of each of the information processing apparatuses obtain the standard time information indicative of standard time kept by the standard clock to ensure that the time keeping means of each of the information processing apparatuses is synchronized to the standard time on the basis of the standard time information obtained by the time obtaining means. Preferably, the input operation period should be kept secret. More preferably, the output operation period should be kept secret.

### BRIEF DESCRIPTION OF THE DRAWINGS

The features and advantages of an information processing apparatus, an information processing method, an information processing system, and an information processing computer program product according to the present invention will be more clearly understood from the following description taken in conjunction with the accompanying drawings in which:

FIG. 1 is a schematic block diagram of a first embodiment of the information processing apparatus according to the present invention;

FIG. 2 is a schematic block diagram of a standard time keeping device forming part of the first embodiment of the information processing apparatus according to the present invention;

FIG. 3 is a flow chart showing an encrypting and decrypting process to be performed by the first embodiment of the information processing apparatus according to the present invention;

FIG. 4 is a flow chart showing a time adjusting process to be performed by the first embodiment of the information processing apparatus according to the present invention;

FIG. 5 is a flow chart showing a standard time receiving process to be performed by the first embodiment of the information processing apparatus according to the present invention;

FIG. 6 is a flow chart showing an initializing process to be performed by the first embodiment of the information processing apparatus according to the present invention;

FIG. 7 is a flow chart showing a voting process to be performed by the first embodiment of the information processing apparatus according to the present invention;

FIG. 8 is a flow chart showing a voting process to be performed by the first embodiment of the information processing apparatus according to the present invention;

FIG. 9 is a flow chart showing a time management process to be performed by the first embodiment of the information processing apparatus according to the present invention;

FIG. 10 is a flow chart showing a time management process to be performed by the first embodiment of the information processing apparatus according to the present invention;

FIG. 11 is a flow chart showing a request signal receiving process to be performed by the first embodiment of the information processing apparatus according to the present invention; and

FIG. 12A is a block diagram of the second embodiment of the information processing system comprising a plurality of information apparatuses respectively located remotely spaced apart from one another.

FIG. 12B is a block diagram of the third embodiment of the information processing system comprising a plurality of information apparatuses respectively located remotely spaced apart from one another across time zones.

FIG. 13 is a block diagram of the conventional electronic voting system.

### DESCRIPTION OF THE EMBODIMENTS

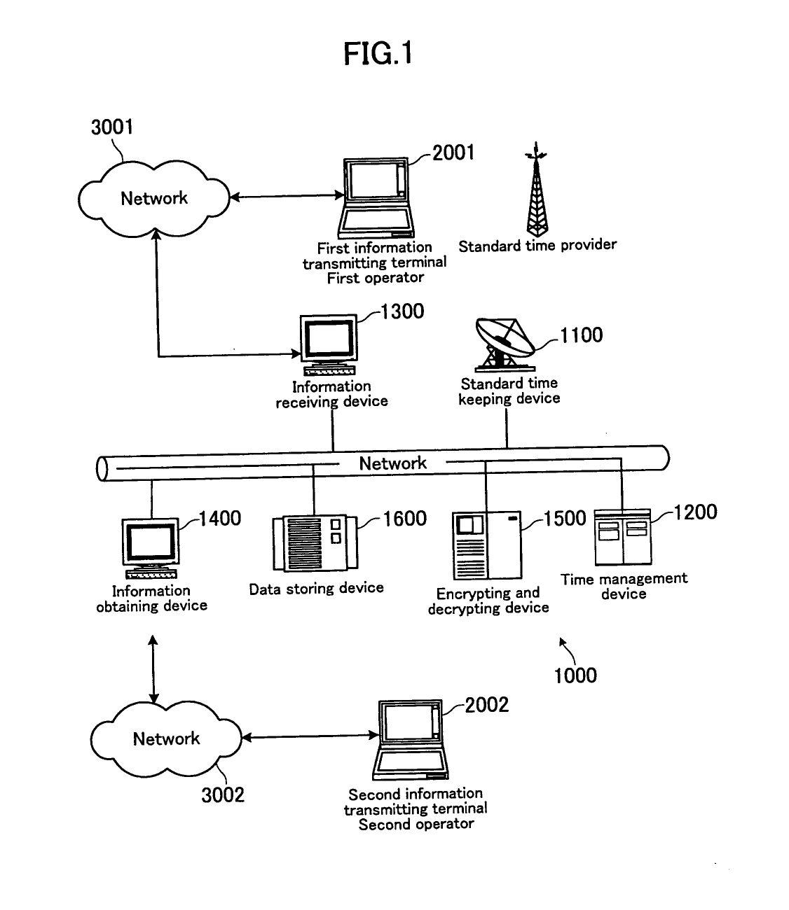

The preferred embodiments of the information processing apparatus according to the present invention will now be described with reference to FIGS. 1 to 11. Throughout the following detailed description, similar reference characters and numbers refer to respective similar elements in all figures of the drawings.

The constitution of the first embodiment of the information processing apparatus 1000 according to the present invention will firstly be described hereinafter with reference to FIG. 1.

The information processing apparatus 1000 is shown in FIG. 1 as comprising a standard time keeping device 1100, a time management device 1200, an information receiving device 1300, an information obtaining device 1400, an encrypting and decrypting device 1500, and a data storing device 1600. The information processing apparatus 1000 is connected with a first information transmitting terminal 2001 through a network 3001. The first information transmitting terminal 2001 is adapted to have a plurality of first operators input a plurality of entry information elements therein, and transmit the entry information elements to the information processing apparatus 1000 through the network 3001. Each of the standard time keeping device 1100, the time management device 1200, the information receiving device 1300, the information obtaining device 1400, the encrypting and decrypting device 1500, and the data storing device 1600 comprises a server computer having an internal clock.

The encrypting and decrypting device 1500 is adapted to set an output operation period after specifying an output start time and an output end time collectively defining the output operation period. The encrypting and decrypting device 1500 constitutes the period setting means according to the present invention. The standard time keeping device 1100 is adapted to keep time including the output start time specified by the encrypting and decrypting device 1500 and the output end time specified by the encrypting and decrypting device 1500. The standard time keeping device 1100 constitutes the time keeping means according to the present invention. The information receiving device 1300 is adapted to receive the entry information elements transmitted from the first information transmitting terminal 2001 through the network 3001. The information receiving device 1300 constitutes the information receiving means according to the present invention.

The encrypting and decrypting device 1500 is adapted to encrypt the entry information elements received from the information receiving device 1300 before producing encrypted information elements. The data storing device 1600 is adapted to store the encrypted information elements produced by the encrypting and decrypting device 1500. The encrypting and decrypting device 1500 is operative to decrypt the encrypted information elements stored in the data storing device 1600 during the output operation period starting from the output start time kept by the standard time keeping device 1100 until the output end time kept by the standard time keeping device 1100. The encrypting and decrypting device 1500 constitutes the information decrypting means according to the present invention.

The information processing apparatus 1000 is operative to process a plurality of entry information elements transmitted from at least one information transmitting terminal 2001. It is hereinlater assumed that the first information transmitting terminal 2001 is operative to have a plurality of first operators, i.e., electors input therein a plurality of voting information elements as entry information elements, and the information processing apparatus 1000 is operative to process a plurality of voting information elements as entry information elements. It is, however, needless to mention that the use of the information processing apparatus 1000 according to the present invention is not limited to the electronic voting, but the information processing apparatus 1000 according to the present invention is available for various purposes such as for example an electronic bidding, auction, and the like.

The standard time keeping device 1100, the time management device 1200, the information receiving device 1300, the information obtaining device 1400, the encrypting and decrypting device 1500, and the data storing device 1600 are connected with one another through a network such as a local area network (LAN).

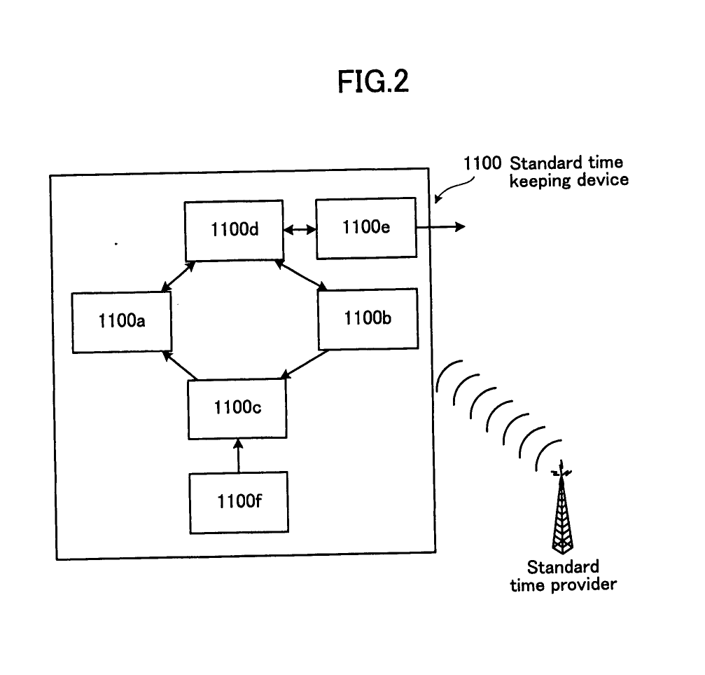

Description will now be made on the standard time keeping device 1100 forming part of the information processing apparatus 1000 with reference to the drawings shown in FIG. 2.

The standard time keeping device 1100 includes a time keeping section 1100a for keeping time, a time obtaining section 1100b for obtaining standard time information indicative of standard time kept by a standard clock, and a time adjusting section 1100c for adjusting the time keeping section 1100a to have the time keeping section 1100a synchronized to the standard time on the basis of the standard time information obtained by the time obtaining section 1100b. The standard time keeping device 1100 constitutes the time keeping means according to the present invention. The time keeping section 1100a of the standard time keeping device 1100 is sometimes referred to as an internal clock of the standard time keeping device 1100. The time keeping section 1100a of the standard time keeping device 1100 serves as an internal clock of the standard time keeping device 1100. The time kept by the time keeping section 1100a of the standard time keeping device 1100 is sometimes referred to as “internal time”. The time obtaining section 1100b of the standard time keeping device 1100 constitutes the time obtaining means according to the present invention.

The standard time keeping device 1100 further includes a radio signal-received lamp, an internal clock-adjusted lamp, an internal time not-adjusted lamp, an out-of-service area lamp, and a current time indicator. The radio signal-received lamp, the internal clock-adjusted lamp, the internal time not-adjusted lamp, and the out-of-service area lamp are designed to indicate operation states of the standard time keeping device 1100.

There is provided a standard time provider for transmitting time signals indicative of standard time via radio at predetermined time intervals. The standard time provider is equipped with an atomic clock for accurately keeping the standard time. Here, as the standard time provider is used a standard frequency and time signal station such as for example NRC Time Services in Canada, BPM in China, Communications Research Laboratory, hereinlater simply referred to as “CRL” in Japan, National Institute of Standards and Technology NIST in USA, or the like. The time obtaining section 1100b of the standard time keeping device 1100 is operative to receive time signals indicative of standard time transmitted by the standard time provider via radio at a predetermined frequency.

The time keeping section 1100a of the standard time keeping device 1100 is operative to keep time. Here, as the time keeping section 1100a of the standard time keeping device 1100 is used a digital clock, which enables the standard time keeping device 1100 to keep time while the time obtaining section 1100b of the standard time keeping device 1100 does not receive the time signals indicative of standard time.

The standard time keeping device 1100 is designed to make it impossible for anyone to manually adjust the time keeping section 1100a, but only allow the time adjusting section 1100c to adjust the time keeping section 1100a to have the time keeping section 1100a synchronized to the standard time on the basis of the standard time information obtained by the time obtaining section 1100b, thereby preventing anyone including third party and internal personal from adjusting the time keeping section 1100a. The time adjusting section 1100c constitutes the time adjusting means according to the present invention.

Further, the standard time keeping device 1100 is designed to make it impossible for anyone to adjust the time adjusting section 1100c except at the factory shipment, thereby preventing anyone including third party and internal personal from manipulating the time adjusting section 1100c to adjust the time keeping section 1100a.

Preferably, the operation of the time adjusting section 1100c should be scheduled. This means that the time adjusting section 1100c may be operative to adjust the time keeping section 1100a to have the time keeping section 1100a synchronized to the standard time on the basis of the standard time information obtained by the time obtaining section 1100b at scheduled time intervals such as for example three minutes, five minutes, ten minutes, thirty minutes, one hour, or the like.

The radio signal-received lamp is operative to turn on under the condition that the time obtaining section 1100b of the standard time keeping device 1100 is operative to receive the time signals indicative of standard time transmitted by the standard time provider via radio at a predetermined frequency. The out-of-service area lamp is operative to turn on under the condition that the time obtaining section 1100b of the standard time keeping device 1100 is located out of the service area and cannot receive the standard time information indicative of standard time transmitted by the standard time provider via radio. The internal clock-adjusted lamp is operative to turn on under the condition that the internal clock of the standard time keeping device 1100 has been adjusted to be synchronized with the standard time. The internal time not-adjusted lamp is operative to turn on under the condition that the internal clock of the standard time keeping device 1100, i.e., the time keeping section 1100a of the standard time keeping device 1100 has not yet been adjusted to be synchronized with the standard time. The current time indicator is operative to indicate time currently kept by the standard time keeping device 1100. Preferably, the current time indicator should indicate the time only if required to do so for security reason.

The standard time keeping device 1100 further includes a log storing section 1100d and a log transmitting section 1100e. The log storing section 1100d is adapted to store therein the error log data after producing error log data indicative of an error of the time kept by the time keeping section 1100a with respect to the standard time on the bass of the standard time information obtained by the time obtaining section 1100b. Further, the log storing section 1100d is operative to produce time log data indicative of the time kept by the time keeping section 1100a after synchronized to the standard time, and store therein the time log data thus produced. The log transmitting section 1100e is operative to transmit the error log data stored in the log storing section 1100d to any one of the server computers forming part of the constituent elements of the information processing apparatus 1000 only if requested. The log storing section 1100d constitutes the error storing means according to the present invention.

The standard time keeping device 1100 may further include a position obtaining section 1100f for obtaining position information indicative of a position thereof. The time adjusting section 1100c is operative to adjust the time keeping section 1100a to have the time keeping section 1100a synchronized to the standard time on the basis of the position information obtained by the position obtaining section 1100f. The position obtaining section 1100f will be described later. The position obtaining section 1100f of the standard time keeping device 1100 constitutes the position obtaining means according to the present invention.

Further, the time keeping section 1100a has a clock rate, at which the time keeping section 1100a is operative to keep time. The time adjusting section 1100c is designed to adjust the clock rate of the time keeping section 1100a on the basis of the error log data produced and stored in the log storing section 1100d. The time adjusting section 1100c, however, may adjust the clock rate of the time keeping section 1100a in a limited range up to several tens of seconds in a day for security reason.

Each of the server computers forming part of the time management device 1200, the information receiving device 1300, the information obtaining device 1400, the encrypting and decrypting device 1500, and the data storing device 1600 is operative to transmit a standard time request signal to the standard time keeping device 1100. The standard time keeping device 1100 is operative to receive the standard time signal indicative of standard time transmitted by the standard time provider via radio at a predetermined frequency, and transmit the time signal to any one or more of the time management device 1200, the information receiving device 1300, the information obtaining device 1400, the encrypting and decrypting device 1500, and the data storing device 1600 in response to the standard time request signal.

This means that the standard time keeping device 1100 is operative to transmit the time signal indicative of standard time transmitted by the standard time provider to one or more of the time management device 1200, the information receiving device 1300, the information obtaining device 1400, the encrypting and decrypting device 1500, and the data storing device 1600 in response to the standard time request signal transmitted by the one or more of the time management device 1200, the information receiving device 1300, the information obtaining device 1400, the encrypting and decrypting device 1500, and the data storing device 1600 under the condition that the standard time keeping device 1100 receives the time signal indicative of standard time transmitted by the standard time provider. The standard time keeping device 1100, on the other hand, is operative to transmit a time signal indicative of time kept by the time keeping section 1100a and a notice signal notifying that the time signal is indicative of time kept by the time keeping section 1100a to one or more of the time management device 1200, the information receiving device 1300, the information obtaining device 1400, the encrypting and decrypting device 1500, and the data storing device 1600 in response to the standard time request signal transmitted by the one or more of the time management device 1200, the information receiving device 1300, the information obtaining device 1400, the encrypting and decrypting device 1500, and the data storing device 1600 under the condition that the standard time keeping device 1100 does not receive the time signal indicative of standard time transmitted by the standard time provider.

Furthermore, each of the time management device 1200, the information receiving device 1300, the information obtaining device 1400, the encrypting and decrypting device 1500, and the data storing device 1600 is operative to transmit a log data request signal to the standard time keeping device 1100. The log transmitting section 1100e of the standard time keeping device 1100 is operative to transmit the error log data stored in the log storing section 1100d to one or more of the time management device 1200, the information receiving device 1300, the information obtaining device 1400, the encrypting and decrypting device 1500, and the data storing device 1600 in response to the log data request signal transmitted by the one or more of the time management device 1200, the information receiving device 1300, the information obtaining device 1400, the encrypting and decrypting device 1500, and the data storing device 1600.

The standard time keeping device 1100 may be placed in the open air with the aim of enhancing reception of time signals transmitted from the standard time provider. Preferably, the standard time keeping device 1100 should be constructed to be water proof and heat resistant. Alternatively, the time obtaining section 1100b of the standard time keeping device 1100 should be constructed to be water proof and heat resistant so that the time obtaining section 1100b of the standard time keeping device 1100 can be located in the open air with the aim of enhancing reception of time signals transmitted from the standard time provider.

Each of the time keeping section 1100a, the time obtaining section 1100b, the time adjusting section 1100c, and the log transmitting section 1100e is required to instantly and seamlessly transfer power from a primary source to an alternate source in the event of interruption or abnormality. This leads to the fact that each of the time keeping section 1100a, the time obtaining section 1100b, the time adjusting section 1100c, and the log transmitting section 1100e is designed to be capable of deriving power not only from a regular power source but also a battery and a power cable such as for example a LAN cable, thereby making it possible for each of the time keeping section 1100a, the time obtaining section 1100b, the time adjusting section 1100c, and the log transmitting section 1100e to derive power from the battery or the power cable in the event of failure of the regular power source.

Description will now be made on the time management device 1200 forming part of the information processing apparatus 1000.

The operations of the time management device 1200 are achieved by executing a plurality of independent memory-resident programs, thereby enabling the time management device 1200 to operate independently from the other programs.

The time management device 1200 is operative to adjust each of the information receiving device 1300, the information obtaining device 1400, the encrypting and decrypting device 1500, and the data storing device 1600 to have each of the server computers forming part of the information receiving device 1300, the information obtaining device 1400, the encrypting and decrypting device 1500, and the data storing device 1600 synchronized to the standard time keeping device 1100 as will be described hereinlater.

The time management device 1200 is operative to transmit a standard time request signal to the standard time keeping device 1100 at a scheduled adjusting time. The standard time keeping device 1100 is operative to transmit the time signal indicative of standard time transmitted by the standard time provider to the time management device 1200 in response to the standard time request signal transmitted by the time management device 1200 under the condition that the standard time keeping device 1100 receives the time signal indicative of standard time transmitted by the standard time provider. The standard time keeping device 1100, on the other hand, is operative to transmit a time signal indicative of time kept by the time keeping section 1100a and a notice signal notifying that the time signal is indicative of time kept by the time keeping section 1100a to the time management device 1200 in response to the standard time request signal transmitted by the time management device 1200 under the condition that the standard time keeping device 1100 does not receive the time signal indicative of standard time transmitted by the standard time provider.

The time management device 1200 is operative to adjust each of internal clocks forming parts of time management device 1200, the information receiving device 1300, the information obtaining device 1400, the encrypting and decrypting device 1500, and the data storing device 1600 to have each of the internal clocks forming part of the time management device 1200, the information receiving device 1300, the information obtaining device 1400, the encrypting and decrypting device 1500, and the data storing device 1600 synchronized to the standard time keeping device 1100 after transmitting the time signal received from the standard time keeping device 1100 to each of the server computers having respective internal clocks forming part of the time management device 1200, the information receiving device 1300, the information obtaining device 1400, the encrypting and decrypting device 1500, and the data storing device 1600 at the scheduled adjusting time.

Further, the time management device 1200 is operative to produce error log data indicative of an error between the time thus adjusted and currently kept by the internal clock forming part of the standard time keeping device 1100 and the time previously kept by the internal clock forming part of the standard time keeping device 1100 before adjusted, an error between the time thus adjusted and currently kept by the internal clock forming part of the time management device 1200 and the time previously kept by the internal clock forming part of the time management device 1200 before adjusted, an error between the time thus adjusted and currently kept by the internal clock forming part of the information receiving device 1300 and the time previously kept by the internal clock forming part of the information receiving device 1300 before adjusted, an error between the time thus adjusted and currently kept by the internal clock forming part of the information obtaining device 1400 and the time previously kept by the internal clock forming part of the information obtaining device 1400 before adjusted, an error between the time thus adjusted and currently kept by the internal clock forming part of the encrypting and decrypting device 1500 and the time previously kept by the internal clock forming part of the encrypting and decrypting device 1500 before adjusted, and an error between the time thus adjusted and currently kept by the internal clock forming part of the data storing device 1600 and the time previously kept by the internal clock forming part of the data storing device 1600 before adjusted at the scheduled adjusting time.

The time management device 1200 has a storage portion having an operation schedule stored therein. The operation schedule includes the scheduled adjusting time. The time management device 1200 may be operative to transmit a standard time request signal to the standard time keeping device 1100 at scheduled time intervals such as for example three minutes, five minutes, ten minutes, thirty minutes, one hour, three hours or the like under the condition that the scheduled adjusting time specifies the scheduled time intervals such as for example three minutes, five minutes, ten minutes, thirty minutes, one hour, three hours or the like. Alternatively, the time management device 1200 may be operative to transmit a standard time request signal to the standard time keeping device 1100 at scheduled time points such as for example every 0 am, 9 am, 12 pm, 5 pm, and the like under the condition that the scheduled adjusting time specifies the time points such as for example every 0 am, 9 am, 12 pm, 5 pm, and the like. Furthermore, the server computers forming part of the information receiving device 1300, the information obtaining device 1400, the encrypting and decrypting device 1500, and the data storing device 1600, and adjust each of internal clocks forming parts of the information receiving device 1300 may transmit a time adjusting signal to the time management device 1200, and the time management device 1200 may be operative to transmit a standard time request signal to the standard time keeping device 1100 in response to the time adjusting signal.

The time management device 1200 is required to encrypt the operation schedule before stored in the storage portion. The encrypted operation schedule is compressed and stored in the storage portion while the time management device 1200 is terminated. The compressed and encrypted operation schedule stored in the storage portion is decompressed when the time management device 1200 is activated. The time management device 1200 is operative to decrypt the encrypted operation schedule stored in the storage portion with decryption key information at predetermined timings. The decryption key information stored in the storage portion is divided into a plurality of information segments. This means that the information segments are separately scattered and stored in the storage portion, thereby making it impossible for third parties to analyze and reproduce the decryption key information in the event that someone should succeed in taking a memory dump of the storage portion.

Furthermore, the time management device 1200 is operative to transmit a log data request signal to the standard time keeping device 1100. The log transmitting section 1100e of the standard time keeping device 1100 is operative to transmit the error log data stored in the log storing section 1100d to the time management device 1200 in response to the log data request signal transmitted by the time management device 1200. The time management device 1200 may be operative to transmit the log data request signal to the standard time keeping device 1100 concurrently with the standard time request signal.

The time management device 1200 is operative to judge whether or not the error of the time kept by the time keeping section 1100a with respect to the standard time is greater than a predetermined value on the basis of the error log data transmitted from the standard time keeping device 1100. The time management device 1200 is operative to notify an administrator that the error occurred in the standard keeping device 1100 when it is judged that the error of the time kept by the time keeping section 1100a with respect to the standard time is greater than the predetermined value.

Further, the time management device 1200 is operative to judge whether or not the error between the time thus adjusted and currently kept by the internal clock forming part of the time management device 1200 and the time previously kept by the internal clock forming part of the time management device 1200 before adjusted is greater than a predetermined threshold value, the error between the time thus adjusted and currently kept by the internal clock forming part of the information receiving device 1300 and the time previously kept by the internal clock forming part of the information receiving device 1300 before adjusted is greater than a predetermined threshold value, the error between the time thus adjusted and currently kept by the internal clock forming part of the information obtaining device 1400 and the time previously kept by the internal clock forming part of the information obtaining device 1400 before adjusted is greater than a predetermined threshold value, the error between the time thus adjusted and currently kept by the internal clock forming part of the encrypting and decrypting device 1500 and the time previously kept by the internal clock forming part of the encrypting and decrypting device 1500 before adjusted is greater than a predetermined threshold value, and the error between the time thus adjusted and currently kept by the internal clock forming part of the data storing device 1600 and the time previously kept by the internal clock forming part of the data storing device 1600 before adjusted is greater than a predetermined threshold value on the basis of the error log data produced by the time management device 1200.

The time management device 1200 is operative to notify the administrator that the error occurred in the time management device 1200 when it is judged that the error between the time thus adjusted and currently kept by the internal clock forming part of the time management device 1200 and the time previously kept by the internal clock forming part of the time management device 1200 before adjusted is greater than a predetermined threshold value. The time management device 1200 is operative to notify the administrator that the error occurred in the information receiving device 1300 when it is judged that the error between the time thus adjusted and currently kept by the internal clock forming part of the information receiving device 1300 and the time previously kept by the internal clock forming part of the information receiving device 1300 before adjusted is greater than a predetermined threshold value. The time management device 1200 is operative to notify the administrator that the error occurred in the information obtaining device 1400 when it is judged that the error between the time thus adjusted and currently kept by the internal clock forming part of the information obtaining device 1400 and the time previously kept by the internal clock forming part of the information obtaining device 1400 before adjusted is greater than a predetermined threshold value. The time management device 1200 is operative to notify the administrator that the error occurred in the encrypting and decrypting device 1500 when it is judged that the error between the time thus adjusted and currently kept by the internal clock forming part of the encrypting and decrypting device 1500 and the time previously kept by the internal clock forming part of the encrypting and decrypting device 1500 before adjusted is greater than a predetermined threshold value. The time management device 1200 is operative to notify the administrator that the error occurred in the data storing device 1600 when it is judged that the error between the time thus adjusted and currently kept by the internal clock forming part of the data storing device 1600 and the time previously kept by the internal clock forming part of the data storing device 1600 before adjusted is greater than a predetermined threshold value.

In the information processing apparatus 1000 according to the present invention, the time obtaining section 11 00b of the standard time keeping device 1100 may be placed in one time zone while the first information transmitting terminal 2001 is operative to have a plurality of electors input a plurality of voting information elements in the other time zone. In this case, the time management device 1200 is operative to calculate local standard time in accordance with the standard time information obtained by the time obtaining section 1100b in consideration of a time difference between the time zone where the time obtaining section 1100b of the standard time keeping device 1100 is operative to obtain the standard time information indicative of standard time, and the time zone where the electors input the voting information elements. Here, the local standard time is intended to mean standard time in the time zone where the first information transmitting terminal 2001 is located, viz., the time zone where the electors input the voting information elements. The time management device 1200 is operative to adjust each of the information receiving device 1300, the information obtaining device 1400, the encrypting and decrypting device 1500, and the data storing device 1600 to have each of the information receiving device 1300, the information obtaining device 1400, the encrypting and decrypting device 1500, and the data storing device 1600 synchronized to the local standard time thus calculated at the scheduled adjusting time.

As described earlier, the time management device 1200 is operative to produce error log data indicative of the error between the time thus adjusted and currently kept by the internal clock forming part of the standard time keeping device 1100 and the time previously kept by the internal clock forming part of the standard time keeping device 1100 before adjusted, the error between the time thus adjusted and currently kept by the internal clock forming part of the time management device 1200 and the time previously kept by the internal clock forming part of the time management device 1200 before adjusted, the error between the time thus adjusted and currently kept by the internal clock forming part of the information receiving device 1300 and the time previously kept by the internal clock forming part of the information receiving device 1300 before adjusted, the error between the time thus adjusted and currently kept by the internal clock forming part of the information obtaining device 1400 and the time previously kept by the internal clock forming part of the information obtaining device 1400 before adjusted, the error between the time thus adjusted and currently kept by the internal clock forming part of the encrypting and decrypting device 1500 and the time previously kept by the internal clock forming part of the encrypting and decrypting device 1500 before adjusted, and the error between the time thus adjusted and currently kept by the internal clock forming part of the data storing device 1600 and the time previously kept by the internal clock forming part of the data storing device 1600 before adjusted at the scheduled adjusting time at the scheduled adjusting time. The time management device 1200 is operative to store the error log data thus produced into the storage portion. Preferably, the time management device 1200 should store the error log data thus produced into a removable storage medium after encrypting the error log data. The time management device 1200 is operative to transmit a log data delete request signal to the standard time keeping device 1100 when the error log data indicative of the error between the time adjusted and currently kept by the internal clock forming part of the standard time keeping device 1100 and the time previously kept by the internal clock forming part of the standard time keeping device 1100 before adjusted is stored in the removable storage medium. The standard time keeping device 1100 is operative to delete the error log data stored in the log storing section 1100d in response to the log data delete request signal.

Description will now be made on the information receiving device 1300 forming part of the information processing apparatus 1000.

The information receiving device 1300 is adapted to receive the entry information elements transmitted from the first information transmitting terminal 2001 through the network 3001 and transmit the entry information elements thus received to the encrypting and decrypting device 1500. Although the information receiving device 1300 is operative to receive the entry information elements transmitted from the first information transmitting terminal 2001 in FIG. 1 for simplicity and better understanding, it is needless to mention that the information receiving device 1300 may be operative to receive a plurality of entry information elements transmitted from two or more terminals through networks. It is hereinlater assumed that the entry information elements received by the information receiving device 1300 are respectively indicative of voting information elements for simplicity and better understanding. It is, however, needless to mention that the entry information elements received by the information receiving device 1300 are not limited to the entry information elements respectively indicative of voting information elements, but the entry information elements may be respectively indicative of any information elements such as for example bidding information elements used for the electronic bidding, and the like. The entry information elements received by the information receiving device 1300 may be different in application from one another.

Preferably, the information receiving device 1300 should be operative to encrypt the entry information elements before transmitting the entry information elements to the encrypting and decrypting device 1500 through a network.

Description will now be made on the encrypting and decrypting device 1500 forming part of the information processing apparatus 1000.

The encrypting and decrypting device 1500 includes an output period setting section 1500a, an input period setting section 1500b, an encrypting section 1500c, a decrypting section 1500d, and a time confirming section 1500e, not shown in FIG. 1.

The output period setting section 1500a of the encrypting and decrypting device 1500 is operative to set an output operation period after specifying an output start time and an output end time collectively defining the output operation period. Further, the input period setting section 1500b of the encrypting and decrypting device 1500 is operative to set an input operation period after specifying an input start time and an input end time collectively defining the input operation period. The encrypting section 1500c of the encrypting and decrypting device 1500 is adapted to encrypt the entry information elements received from the information receiving device 1300 before producing encrypted information elements. The data storing device 1600 is operative to store the encrypted information elements produced by the encrypting section 1500c. The decrypting section 1500d of the encrypting and decrypting device 1500 is adapted to decrypt the encrypted information elements stored in the data storing device 1600. The encrypting section 1500c of the encrypting and decrypting device 1500 constitutes the information encrypting means according to the present invention. The decryption section 1500d of the encrypting and decrypting device 1500 constitutes the information decrypting means according to the present invention. The time confirming section 1500e is operative to transmit a standard time request signal to the standard time keeping device 1100. The standard time keeping device 1100 is operative to transmit the time signal indicative of standard time transmitted by the standard time provider or time kept by the time keeping section 1100a of the standard time keeping device 1100 to the time confirming section 1500e in response to the standard time request signal transmitted by the time confirming section 1500e of the encrypting and decrypting device 1500.

The time confirming section 1500e may be operative to transmit the standard time request signal to the standard time keeping device 1100 at a predetermined time interval, and adjust the internal clock forming part of encrypting and decrypting device 1500 to have the internal clock forming part of encrypting and decrypting device 1500 synchronized to the standard time keeping device 1100 on the basis of the time signal received from the standard time keeping device 1100. The time interval may be specified by an administrator in units of seconds such as for example 0.1 second, 0.5 second, 1 second, 3 seconds, 5 seconds, to 500 seconds.

In the information processing apparatus according to the present invention, the encrypting and decrypting device 1500 is operative to encrypt and decrypt information elements in a specified time period as will be described hereinlater.

The input period setting section 1500b of the encrypting and decrypting device 1500 is operative to set an input operation period after specifying an input start time and an input end time collectively defining the input operation period. The standard time keeping device 1100 is operative to keep time including the input start time specified by the input period setting section 1500b and the input end time specified by the input period setting section 1500b. The information receiving device 1300 is operative to receive the entry information elements transmitted from the first information transmitting terminal 2001 during the input operation period starting from the input start time kept by the standard time keeping device 1100 until the input end time kept by the standard time keeping device 1100.

More specifically, the information receiving device 1300 is operative to transmit a receipt signal to the time confirming section 1500e of the encrypting and decrypting device 1500 upon receiving the entry information elements transmitted from the first information transmitting terminal 2001. The time confirming section 1500e is operative to judge whether or not the time currently kept by the standard time keeping device 1100 indicates time during the input operation period starting from the input start time kept by the standard time keeping device 1100 until the input end time kept by the standard time keeping device 1100 on the basis of the time signal received from the standard time keeping device 1100 in response to the receipt signal transmitted from the information receiving device 1300.

When it is judged by the time confirming section 1500e that the time currently kept by the standard time keeping device 1100 indicates time during the input operation period starting from the input start time kept by the standard time keeping device 1100 until the input end time kept by the standard time keeping device 1100, the time confirming section 1500e allows the information receiving device 1300 to receive the entry information elements transmitted from the first information transmitting terminal 2001. When it is, on the other hand, judged by the time confirming section 1500e that the time currently kept by the standard time keeping device 1100 does not indicates time during the input operation period starting from the input start time kept by the standard time keeping device 1100 until the input end time kept by the standard time keeping device 1100, the time confirming section 1500e is operative to prohibit the information receiving device 1300 to receive the entry information elements transmitted from the first information transmitting terminal 2001 and returns an error signal to the information receiving device 1300. The encrypting section 1500c of the encrypting and decrypting device 1500 is operative to encrypt the entry information elements received from the information receiving device 1300. The decryption section 1500d of the encrypting and decrypting device 1500 is operative to decrypt the encrypted entry information elements in response to the decryption request signal from the information obtaining device 1400. The encrypting section 1500c of the encrypting and decrypting device 1500 is operative to encrypt the entry information elements received from the information receiving device 1300 in accordance with a predetermined encrypting method before producing encrypted entry information elements. This means that the encrypting section 1500c is operative to encrypt predetermined parts of the entry information elements received from the information receiving device 1300 in accordance with the predetermined encrypting method. The data storing device 1600 is operative to store the encrypted entry information elements produced by the encrypting section 1500c.

The output period setting section 1500a of the encrypting and decrypting device 1500 is operative to set an output operation period after specifying an output start time and an output end time collectively defining the output operation period. The standard time keeping device 1100 is operative to keep time including the output start time specified by the output period setting section 1500a and the output end time specified by the output period setting section 1500a. The decrypting section 1500d is operative to decrypt the encrypted entry information elements stored in the data storing device 1600 during the output operation period starting from the output start time kept by the standard time keeping device 1100 until the output end time kept by the standard time keeping device 1100.

More specifically, the time confirming section 1500e is operative to judge whether or not the time currently kept by the standard time keeping device 1100 indicates time during the output operation period starting from the output start time kept by the standard time keeping device 1100 until the output end time kept by the standard time keeping device 1100 on the basis of the time signal received from the standard time keeping device 1100.

When it is judged by the time confirming section 1500e that the time currently kept by the standard time keeping device 1100 indicates time during the output operation period starting from the output start time kept by the standard time keeping device 1100 until the output end time kept by the standard time keeping device 1100, the time confirming section 1500e allows the decrypting section 1500d to decrypt the encrypted entry information elements stored in the data storing device 1600. When it is, on the other hand, judged by the time confirming section 1500e that the time currently kept by the standard time keeping device 1100 does not indicate time during the output operation period starting from the output start time kept by the standard time keeping device 1100 until the output end time kept by the standard time keeping device 1100, the time confirming section 1500e prohibits the decrypting section 1500d to decrypt the encrypted entry information elements stored in the data storing device 1600 and returns an error signal to the information obtaining device 1400.

The decrypting section 1500d is operative to decrypt the encrypted entry information elements stored in the data storing device 1600 in accordance with a predetermined decrypting method. The predetermined decrypting method corresponds to the encrypting method, in accordance with which the encrypting section 1500c has produced the encrypted entry information elements after encrypting the entry information elements. This means that the decrypting section 1500d is operative to detect the encrypted parts of the encrypted entry information elements from among the encrypted entry information elements stored in the data storing device 1600 before decrypting the encrypted parts of the encrypted entry information elements stored in the data storing device 1600 in accordance with the decrypting method.

The decrypting section 1500d is then operative to encrypt the entry information elements thus encrypted before transmitting the entry information elements to the information obtaining device 1400. Preferably, the decrypting section 1500d should encrypt the entry information elements thus encrypted in accordance with an encrypting method such as for example a Secure Sockets Layer encrypting method, hereinlater simply referred to as “SSL”, or the like before transmitting the entry information elements to the information obtaining device 1400.

Description will now be made on the data storing device 1600 forming part of the information processing apparatus 1000.

The data storing device 1600 is operative to store the encrypted entry information elements produced by the encrypting and decrypting device 1500.

The data storing device 1600 further includes a time adjusting section 1600a and a log producing section 1600b.

The time adjusting section 1600a of the data storing device 1600 is operative to transmit the standard time request signal to the standard time keeping device 1100 at a predetermined time interval, and adjust the internal clock forming part of encrypting and data storing device 1600 to have the internal clock forming part of encrypting and data storing device 1600 synchronized to the standard time keeping device 1100 on the basis of the time signal received from the standard time keeping device 1100. The time interval may be specified by an administrator in units of seconds such as for example 0.1 second, 0.5 second, 1 second, 3 seconds, 5 seconds, to 500 seconds.

The log producing section 1600b is operative to produce error log data indicative of an error between the time thus adjusted and currently kept by the internal clock forming part of the data storing device 1600 and the time previously kept by the internal clock forming part of the data storing device 1600 before adjusted whenever the time adjusting section 1600a is operated to adjust the internal clock forming part of encrypting and data storing device 1600 to have the internal clock forming part of encrypting and data storing device 1600 synchronized to the standard time keeping device 1100. Furthermore, the log producing section 1600b is operative to attach a time stamp to the error log data, and encrypting the error log data with the time stamp attached thereto before storing the error log data thus produced into a removable storage medium.

Description will now be made on the information obtaining device 1400 forming part of the information processing apparatus 1000.

The information obtaining device 1400 is connected with a second information transmitting terminal 2002 through, for example, a network 3002. The second information transmitting terminal 2002 is operative to have a second operator input an information output instruction, and transmit the information output instruction to the information obtaining device 1400.

The information obtaining device 1400 is operative to transmit a decryption request signal to the encrypting and decrypting device 1500 in response to the information output instruction received from the second information transmitting terminal 2002. The time confirming section 1500e of the encrypting and decrypting device 1500 is operative to judge whether or not the time currently kept by the standard time keeping device 1100 indicates time during the output operation period starting from the output start time kept by the standard time keeping device 1100 until the output end time kept by the standard time keeping device 1100 on the basis of the time signal received from the standard time keeping device 1100 in response to the decryption request signal transmitted from the information obtaining device 1400. The decryption section 1500d of the encrypting and decrypting device 1500 is operative to decrypt the encrypted entry information elements in response to the decryption request signal from the information obtaining device 1400 when it is judged by the time confirming section 1500e that the time currently kept by the standard time keeping device 1100 indicates time during the output operation period starting from the output start time kept by the standard time keeping device 1100 until the output end time kept by the standard time keeping device 1100. The information obtaining device 1400 constitutes the instruction accepting means according to the present invention.

The information obtaining device 1400 is operative to receive the entry information elements from the decrypting section 1500d of the encrypting and decrypting device 1500, and transmit the entry information elements to the second information transmitting terminal 2002 through the network 3002. Although the information obtaining device 1400 is operative to output the entry information elements to the second information transmitting terminal 2002 in FIG. 1 for simplicity and better understanding, it is needless to mention that the information obtaining device 1400 may be operative to transmit the entry information elements to two or more terminals through the networks. The entry information elements received by the information obtaining device 1400 are not limited to the entry information elements respectively indicative of voting information elements, but the entry information elements may be respectively indicative of any information elements such as for example bidding information elements used for the electronic bidding, and the like. The entry information elements may be different in application from one another.

Preferably, the information obtaining device 1400 should be operative to encrypt the entry information elements before transmitting the entry information elements to the second information transmitting terminal 2002 through the network 3002.

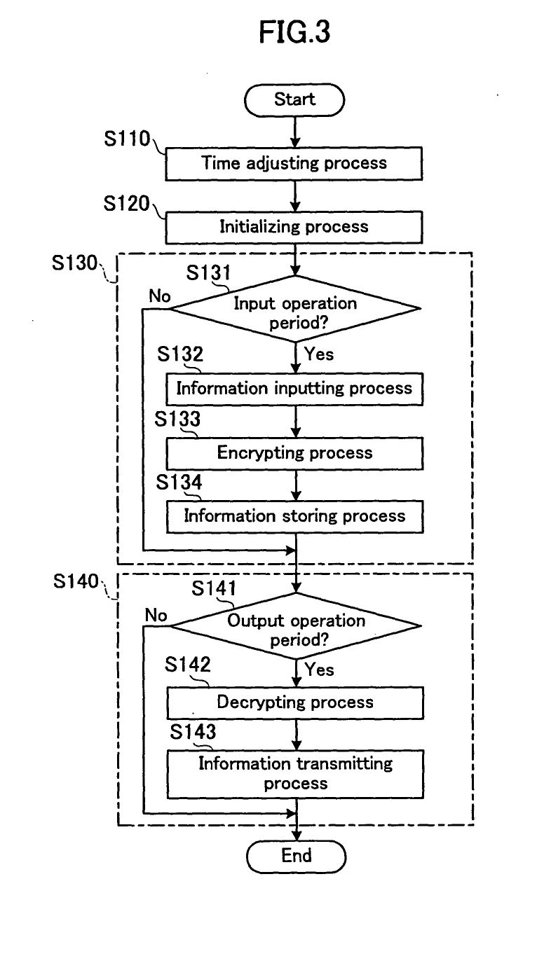

The following description will now be directed to the encrypting and decrypting process to be performed by the first embodiment of the information processing apparatus according to the present invention with reference to the flowcharts shown in FIG. 3.

In the step S110 of the time adjusting process, the standard time keeping device 1100 is adjusted to be synchronized to the standard time on the basis of the standard time information. The internal clocks forming part of the time management device 1200, the information receiving device 1300, the information obtaining device 1400, the encrypting and decrypting device 1500, and the data storing device 1600 are adjusted to be synchronized to the standard time keeping device 1100.

The step S110 goes forward to the step S120 of the initializing process, in which the operations of the standard time keeping device 1100, the time management device 1200, the information receiving device 1300, the information obtaining device 1400, the encrypting and decrypting device 1500, and the data storing device 1600 are scheduled. The input and output operation periods are specified in the step S110.

The step S120 goes forward to the step S130 of the voting process, in which the voting process is performed. The step S130 goes forward to the step S140 of the vote counting process, in which the vote counting process is performed.

The following description will be directed to the step S130 of the voting process.

In the step S131, the information receiving device 1300 is operated to transmit a receipt signal to the time confirming section 1500e of the encrypting and decrypting device 1500 upon receiving the entry information elements transmitted from the first information transmitting terminal 2001. The time confirming section 1500e is operative to judge whether or not the time currently kept by the standard time keeping device 1100 indicates time during the input operation period specified in the step S120 starting from the input start time kept by the standard time keeping device 1100 until the input end time kept by the standard time keeping device 1100 on the basis of the time signal received from the standard time keeping device 1100 in response to the receipt signal transmitted from the information receiving device 1300.

When it is judged by the time confirming section 1500e that the time currently kept by the standard time keeping device 1100 indicates time during the input operation period, the step S131 goes forward to the step S132.

In the step S132 of the information receiving process, the entry information elements inputted by the first information transmitting terminal 2001 are received by the information receiving device 1300.

The step S132 goes forward to the step S133 of the encrypting process, in which the encrypting and decrypting device 1500 is operated to encrypt the entry information elements received by the information receiving device 1300 and produce the encrypted entry information elements. The step S133 goes forward to the step S134 of the information storing process, in which the data storing device 1600 is operated to store therein the encrypted entry information elements produced by the encrypting and decrypting device 1500.

The voting process from the step S131 to the step S134 are repeated until it is judged in the step S131 that the time currently kept by the standard time keeping device 1100 does not indicate time during the input operation period. When it is judged by the time confirming section 1500e in the step S131 that the time currently kept by the standard time keeping device 1100 does not indicate time during the input operation period, the time confirming section 1500e is operated to prohibit the information receiving device 1300 to receive the entry information elements transmitted from the first information transmitting terminal 2001 and returns an error signal to the information receiving device 1300. The step S130 of the voting process is thus terminated.

The step S130 of the voting process goes forward to the step S140 of the vote counting process.

The following description will be directed to the step S140 of the vote counting process.

In the step S141 of the output instruction receiving process, the second information transmitting terminal 2002 is operated to have a second operator input an information output instruction, and transmit the information output instruction to the information obtaining device 1400. The information obtaining device 1400 is operated to transmit a decryption request signal to the encrypting and decrypting device 1500 in response to the information output instruction received from the second information transmitting terminal 2002. The time confirming section 1500e of the encrypting and decrypting device 1500 is operated to judge whether or not the time currently kept by the standard time keeping device 1100 indicates time during the output operation period specified in the step S120 starting from the output start time kept by the standard time keeping device 1100 until the output end time kept by the standard time keeping device 1100 on the basis of the time signal received from the standard time keeping device 1100 in response to the decryption request signal transmitted from the information obtaining device 1400. When it is judged by the time confirming section 1500e that the time currently kept by the standard time keeping device 1100 indicates time during the output operation period starting from the output start time kept by the standard time keeping device 1100 until the output end time kept by the standard time keeping device 1100, the time confirming section 1500e is operated to allow the decryption section 1500d of the encrypting and decrypting device 1500 to decrypt the encrypted entry information elements, and the step S141 goes to the step S142.

In the step S142, the decryption section 1500d of the encrypting and decrypting device 1500 is operated to decrypt the encrypted entry information elements stored in the data storing device 1600. The step S142 goes forward to the step S143, in which the decryption section 1500d of the encrypting and decrypting device 1500 is operated to transmit the entry information elements to the information obtaining device 1400. The information obtaining device 1400 is operated to output the entry information elements to the second information transmitting terminal 2002 through the network 3002.

When it is, on the other hand, judged by the time confirming section 1500e in the step S141 that the time currently kept by the standard time keeping device 1100 does not indicate time during the output operation period starting from the output start time kept by the standard time keeping device 1100 until the output end time kept by the standard time keeping device 1100, the time confirming section 1500e is operated to prohibit the decryption section 1500d of the encrypting and decrypting device 1500 to decrypt the encrypted entry information elements, and return an error signal to the decryption section 1500d of the encrypting and decrypting device 1500. The step S140 of the vote counting process is thus terminated, and the encrypting and decrypting process goes to end.

The second information transmitting terminal 2002 is placed in, for example, an election administration office, thereby making it possible for election administrators to count the votes cast for each candidate and/or party on the basis of the entry information elements thus received from the information obtaining device 1400. The second operator should be a staff member of the election administrator office.

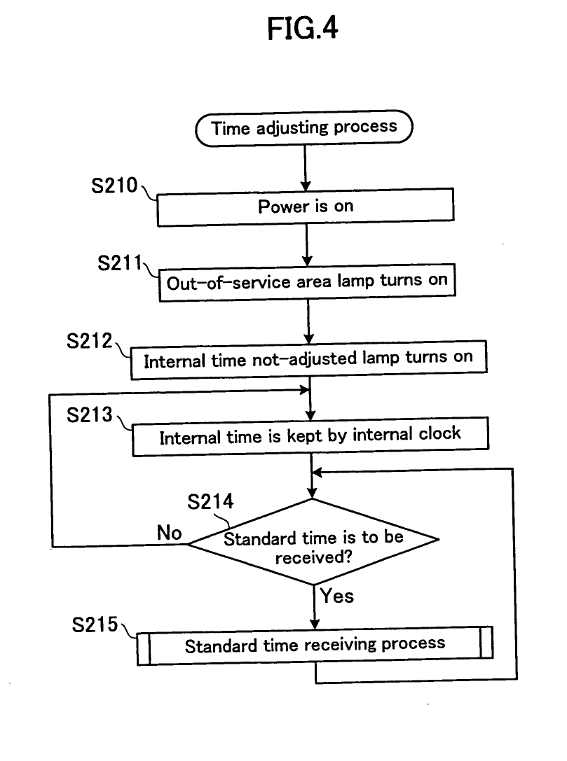

The following description will be directed to the step S110 of the time adjusting process in detail with reference to the flow chart shown in FIG. 4.

In the step S210, the standard time keeping device 1100 is powered on. The step S210 goes forward to the step S211, in which the out-of-service area lamp turns on. The step S211 goes forward to the step S212, in which the internal time not-adjusted lamp turns on. The step S212 goes forward to the step S213, in which internal time is kept by the internal clock forming part of the standard time keeping device 1100. The step S213 goes forward to the step S214, in which it is judged whether or not the standard time is to be received. This means that it is judged whether or not the internal time indicates that it is a scheduled adjusting time. When it is judged in the step S214 that the internal time indicates it is the scheduled adjusting time, i.e., the standard time is to be received, the step S214 goes to the step S215. When it is, on the other hand, judged in the step S214 that the internal time indicates that it is not the scheduled adjusting time, i.e., the standard time is not to be received, the step S214 goes back the step S213. In the step S215, the standard time is received. The steps S213, S214 and S215 are repeated and the step S215 of the standard time receiving process is carried out when it is judged that the internal time indicates that it is the scheduled adjusting time in the step S214.

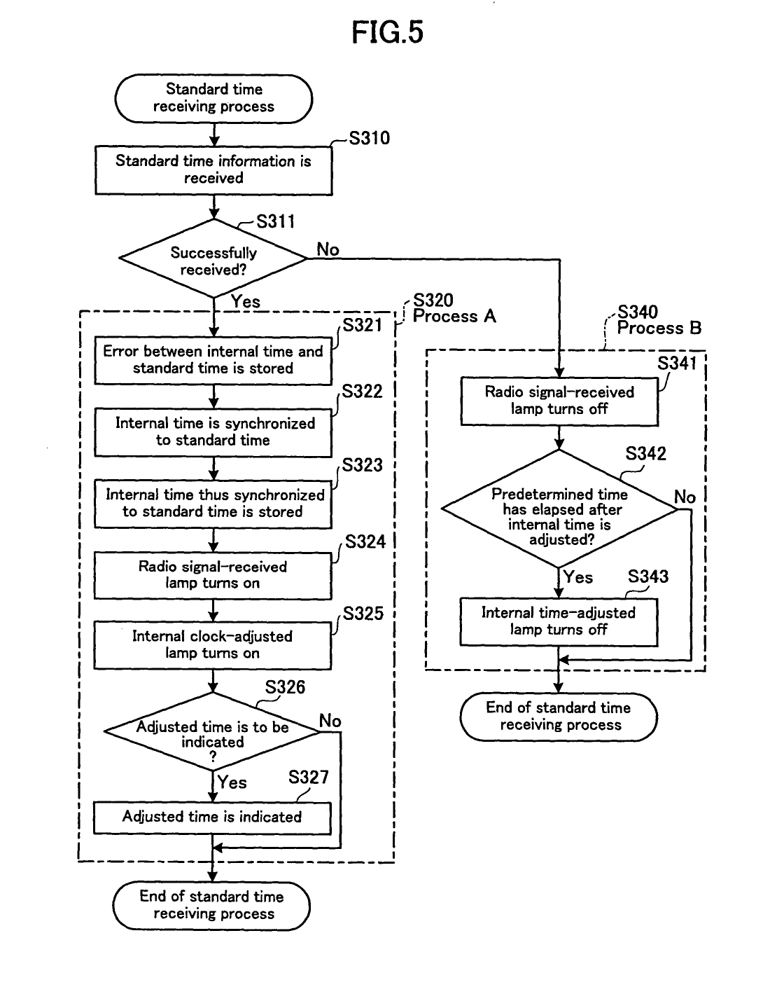

The following description will be directed to the step S215 of the standard time receiving process in detail with reference to the flow chart shown in FIG. 5.

In the step S310, the time obtaining section 1100b of the standard time keeping device 1100 is operated to receive the time signals indicative of standard time transmitted by the standard time provider via radio at a predetermined frequency. Here, as the standard time provider is used a standard frequency and time signal station such as for example NRC Time Services in Canada, BPM in China, Communications Research Laboratory, hereinlater simply referred to as “CRL” in Japan, National Institute of Standards and Technology NIST in USA, or the like.

Preferably, the time obtaining section 1100b of the standard time keeping device 1100 should be located in the open air with the aim of enhancing reception of time signals transmitted from the standard time provider. The time obtaining section 1100b of the standard time keeping device 1100 should be constructed to be water proof and heat resistant.

The step S310 goes forward to the step S311, in which it is judged whether or not the time signal is successfully received. When it is judged that the time signal is successfully received, the step S311 goes forward to the step S320 of process A.

In the step S320, the log storing section 1100d of the standard time keeping device 1100 is operated to calculate an error of internal time kept by the time keeping section 1100a of the standard time keeping device 1100 with respect to the standard time on the bass of the standard time information obtained by the time obtaining section 1100b in the step S310. The log storing section 1100d of the standard time keeping device 1100 is then operated to store therein the error log data after producing error log data indicative of an error of the internal time kept by the time keeping section 1100a with respect to the standard time in the step S321.

The step S321 goes forward to the step S322, in which the time adjusting section 1100c of the standard time keeping device 1100 is operated to adjust the time keeping section 1100a of the standard time keeping device 1100 to have the internal time kept by the time keeping section 1100a synchronized to the standard time on the basis of the standard time information obtained by the time obtaining section 1100b.

The step S322 goes forward to the step S323, in which the log storing section 1100d of the standard time keeping device 1100 is operated to produce time log data indicative of the internal time kept by the time keeping section 1100a after adjusted and synchronized to the standard time, and store therein the time log data thus produced.

The step S323 goes forward to the step S324, in which the radio signal-received lamp is operated to turn on. The step S324 goes forward to the step S325, in which the internal clock-adjusted lamp is operative to turn on.

The step S325 goes forward to the step S326, in which it is judged whether or not the adjusted time is to be indicated. When it is judged that the adjusted time is to be indicated, the step S326 goes forward to the step S327, in which the current time indicator is operated to indicate the internal time thus adjusted and currently kept by the standard time keeping device 1100. When it is, on the other hand, judged that the adjusted time is not to be indicated, the step S326 goes forward to the end of the standard time receiving process. Preferably, the current time indicator should indicate the time only if required to do so for security reason. The step S327 goes forward to the end of the standard time receiving process.

When it is judged in the step S311 that the time signal is not successfully received, the step S311 goes forward to the step S340 of process B, which will be described hereinlater.

In the step S341, the radio signal-received lamp is operated to turn off. The step S341 goes forward to the step S342, in which it is judged whether or not a predetermined time has elapsed after the internal time is adjusted. The operation of the time adjusting section 1100c is scheduled. This means that the time adjusting section 1100c is operated to adjust the time keeping section 1100a to have the time keeping section 1100a synchronized to the standard time on the basis of the standard time information obtained by the time obtaining section 1100b at a scheduled time interval such as for example three minutes, five minutes, ten minutes, thirty minutes, one hour, or the like as described earlier. In the step S342, it is judged whether or not the predetermined time, i.e., the scheduled time interval has elapsed after the internal time is adjusted. When it is judged that the predetermined time has elapsed after the internal time is adjusted, the step S342 goes forward to the step S343, in which the internal clock-adjusted lamp is operated to turn off. When it is, on the other hand, judged that the predetermined time has not yet elapsed after the internal time is adjusted, the step S342 goes forward to the end of the standard time receiving process. The step S343 goes forward to the end of the standard time receiving process.

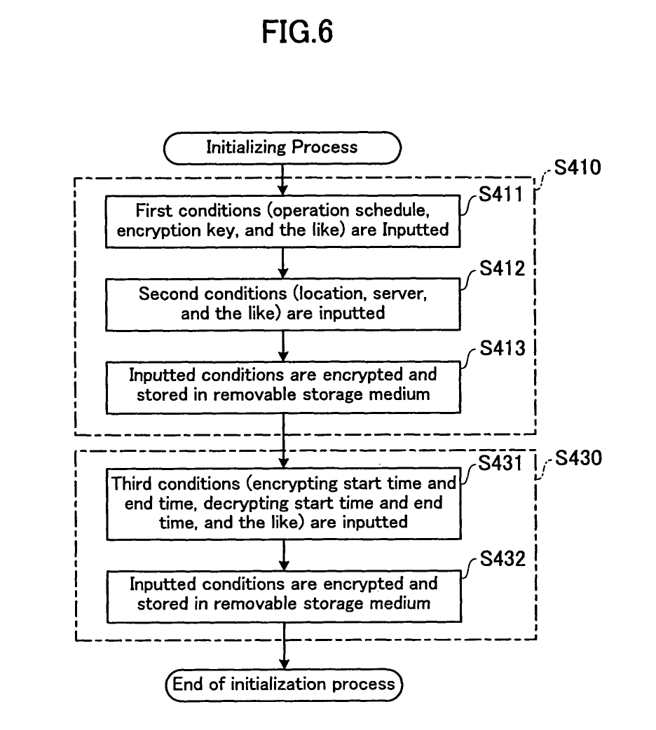

The following description will be directed to step S120 of the initializing process in detail with reference to the flow chart shown in FIG. 6.

The step S120 of the initializing process is constituted by a condition setting process to be performed in the step S410 and an encryption and decryption condition setting process to be performed in the step S430.

In the step S410 of the condition setting process, first and second conditions are inputted and stored as will be described hereinlater.

In the step S411, the first conditions such as an operation schedule of the information processing apparatus 1000, encryption and decryption information for use in encrypting and decrypting operations to be carried out in the information processing apparatus 1000, and the like are inputted in the step S411. This means that the operations of the standard time keeping device 1100 and time management device 1200 are scheduled, and the encryption and decryption keys for use in encrypting and decrypting operations to be carried out in the encrypting and decrypting device 1500 are inputted.

The step S411 goes forward to the step S412, in which second conditions such as a location of the information processing apparatus 1000, server computers forming part of the information processing apparatus 1000, and the like are inputted. Here, the server computers are intended to mean the computers forming part of the standard time keeping device 1100, the time management device 1200, the information receiving device 1300, the information obtaining device 1400, the encrypting and decrypting device 1500, and the data storing device 1600, and the time management device 1200 is operative to adjust each of the computers to have the internal time of each of the computers synchronized to the standard time keeping device 1100.

The step S412 goes forward to the step S413, in which the first and second conditions inputted in the steps S411 and S412 are encrypted and stored in removable medium such as a disk. Preferably, the removable medium should be kept in a safe place when not in use for security reason.

In the step S430 of the encryption and decryption condition setting process, the third conditions are inputted and stored as will be described hereinlater.

In the step S431, third conditions are inputted. The third conditions include operation periods such as such as for example the output start time and the output end time collectively defining the output operation period, and the input start time and the input end time collectively defining the input operation period. The encrypting and decrypting device 1500 is operative to decrypt the encrypted entry information elements stored in the data storing device 1600 during the output operation period. The output start time and the output end time collectively defining the output operation period are sometimes referred to as “decrypting start time” and “decrypting end time”. The information receiving device 1300 is operative to receive the entry information elements transmitted from the first information transmitting terminal 2001 during the input operation period. The encrypting and decrypting device 1500 is operative to encrypt the entry information elements received from the information receiving device 1300. The input start time and the input end time collectively defining the input operation period are sometimes referred to as “encrypting start time” and “encrypting end time”.

The step S431 goes forward to the step S432, in which the inputted conditions are encrypted and stored in removable medium such as a disk. Preferably, the removable medium should be kept in a safe place when not in use for security reason.

Although there has been described in the about that that the initializing process is constituted by the condition setting process performed in the step S410 and the encryption and decryption condition setting process performed in the step 430 with reference to the flow chart shown in FIG. 6 for simplicity and better understanding, it is needless to mention that the initializing process to be performed by the image processing apparatus 1000 according to the present invention may be constituted by other processes.

Furthermore, in the step S431, an election administrator may input a voting period as the input operation period after specifying a vote start time and a vote end time collectively defining the voting period, and a vote counting period as the output operation period after specifying a vote counting start time and vote counting end time as will be described hereinlater. The voting period and the vote counting period should be kept secret for security reason.

The election administrator inputs the voting period through the second information transmitting terminal 2002, and have the input period setting section 1500b of the encrypting and decrypting device 1500 set the voting period as the input operation period after specifying the vote start time and the vote end time collectively defining the voting period. The voting period is required to be kept secret. The election administrator must not let anyone including third party and internal personal know the voting period. The standard time keeping device 1100 is operated to keep time including the vote start time specified by the input period setting section 1500b and the vote end time specified by the input period setting section 1500b. The information receiving device 1300 is operative to receive the entry information elements transmitted from the first information transmitting terminal 2001 during the voting period starting from the vote start time kept by the standard time keeping device 1100 until the vote end time kept by the standard time keeping device 1100. The first information transmitting terminal 2001 is operated under the control of the election administrator. The election administrator may allow the first information transmitting terminal 2001 to transmit the entry information elements to the information receiving device 1300 via the network 3001 during the voting period only.

The election administrator inputs the vote counting period through the second information transmitting terminal 2002, and have the output period setting section 1500a of the encrypting and decrypting device 1500 to set the vote counting period as an output operation period after specifying the vote counting start time and the vote counting end time collectively defining the vote counting period. The vote counting period is required to be kept secret. The election administrator must not let anyone including third party and internal personal know the vote counting period. The decrypting section 1500d is operative to decrypt the encrypted entry information elements stored in the data storing device 1600 during the vote counting period starting from the vote counting start time kept by the standard time keeping device 1100 until the vote counting end time kept by the standard time keeping device 1100.

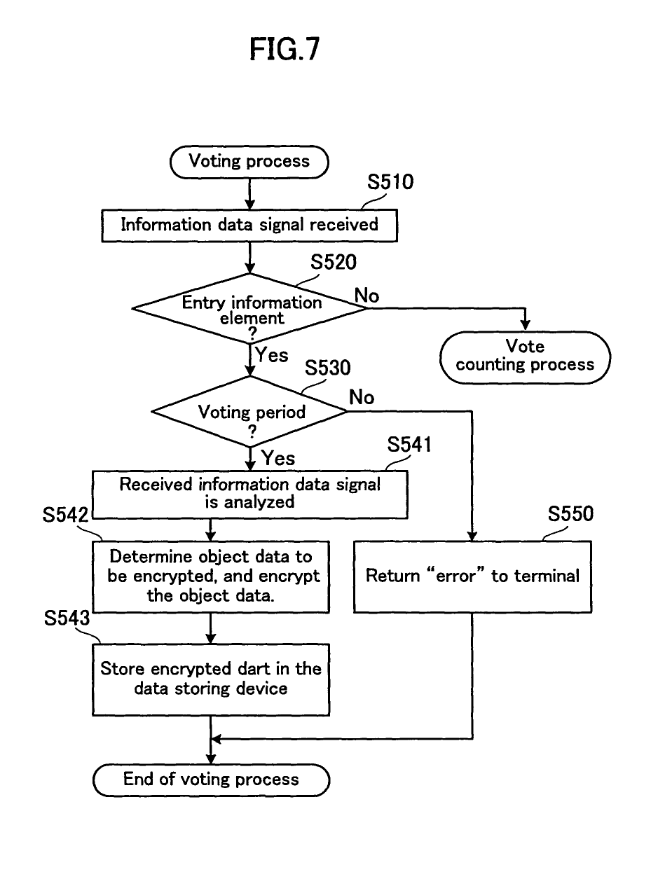

The following description will now be directed to the voting process performed in the step S130 with reference to the drawings shown in FIG. 7.

In the step S510, electors input voting information elements as the entry information elements into the first information transmitting terminal 2001. Here, the voting information element is intended to mean a vote cast by an elector for a candidate and/or party. The first information transmitting terminal 2001 is operated to transmit an information data signal including the entry information elements to the information processing apparatus 1000. Preferably, the first information transmitting terminal 2001 should transmit the information data signal to the information processing apparatus 1000 after encrypting the information data signal. The information processing apparatus 1000 is operated to receive the information data signal transmitted from the first information transmitting terminal 2001 through the network 3001.

The step S510 goes forward to the step S520, in which the information processing apparatus 1000 is operated to judge whether or not the information data signal received from the first information transmitting terminal 2001 includes the entry information element. When it is judged that the information data signal received from the first information transmitting terminal 2001 includes the information element, the step S520 goes to the step S530.

In the step S530, the information receiving device 1300 is operated to transmit a receipt signal to the time confirming section 1500e of the encrypting and decrypting device 1500. The time confirming section 1500e is operated to judge whether or not the time currently kept by the standard time keeping device 1100 indicates time during the voting period. When it is judged that the time currently kept by the standard time keeping device 1100 indicates time during the voting period, the step S530 goes to the step S541.

In the step S541, the time conforming section 1500e is operated to allow the information receiving device 1300 to receive the information data signal transmitted from the first information transmitting terminal 2001. The encrypting section 1500c is operated to analyze the information data signal received from the information receiving device 1300.

The step S541 goes forward to the step S542, in which the encrypting section 1500c of the encrypting and decrypting device 1500 is operated to determine parts of the information data signal, i.e., entry information elements as object data to be encrypted, and encrypt the object data.

The step S542 goes forward to the step S543, in which the encrypting section 1500c is operated to store the encrypted data encrypted in the step S542 in the data storing device 1600. The step S543 goes to the end of the voting process.

When it is, on the other hand, judged that the time currently kept by the standard time keeping device 1100 does not indicate time during the voting period, the step S530 goes to the step S550. In the step S550, the time conforming section 1500e is operated to return an error signal to the information receiving device 1300 and prohibit the information receiving device 1300 to receive the entry information elements transmitted from the first information transmitting terminal 2001. The step S550 goes to the end of the voting process.

As will be seen from the foregoing description, it is to be understood that the information processing apparatus 1000 according to the present invention comprising the input period setting section 1500b of the encrypting and decrypting device 1500 for setting an input operation period, viz., the voting period, after specifying the vote start time and the vote end time collectively defining the voting period, and the standard time keeping device 1100 is operative to keep time including the vote start time specified by the input period setting section 1500b and the vote end time specified by the input period setting section 1500b, and the information receiving device 1300 is operative to receive the voting information elements transmitted from first information transmitting terminal 2001 via the network 3001 during the voting period starting from the vote start time kept by the standard time keeping device 1100 until the vote end time kept by the standard time keeping device 1100, wherein the voting period is kept secret, makes it impossible anyone including third party and internal personnel to collect the entry information elements while being transmitted through the network 3001 in the voting period, thereby making it impossible for third parties to crack the encryption information and decrypt the encrypted entry information elements, and protecting privacy of electors. Furthermore, the information processing apparatus 1000 according to the present invention does not allow anyone including third party and internal personnel to input voting information elements into the information receiving device 1300 after or before the voting period, and make it impossible tap or falsify the entry information elements stored in data storing device 1600, thereby ensuring a fair and impartial election and a protection of privacy.

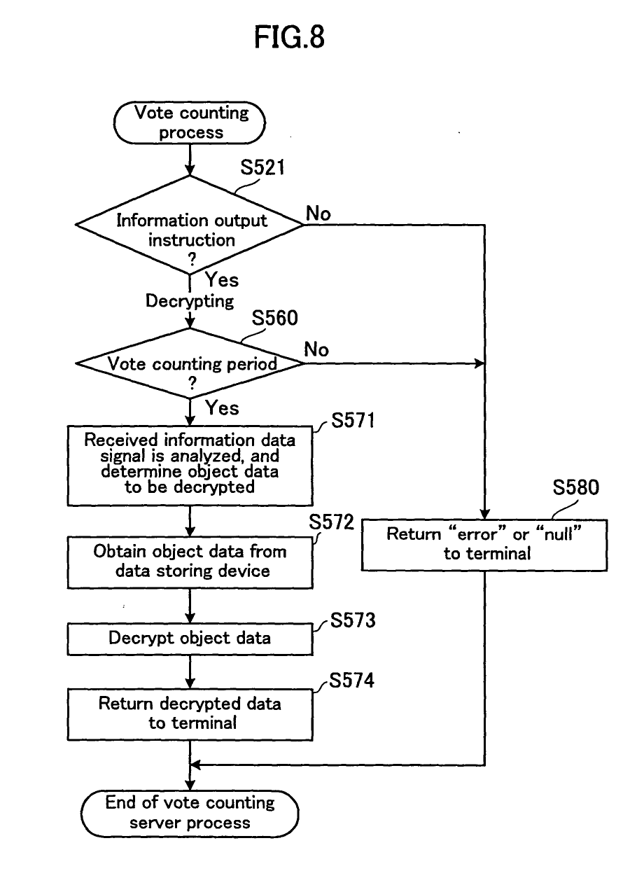

The following description will now be directed to the vote counting process performed in the step S140 with reference to the drawings shown in FIGS. 7 and 8.

In the step S510, the election administrator inputs an information output instruction into the second information transmitting terminal 2002. The second information transmitting terminal 2002 is operated to transmit an information data signal indicative of the information output instruction to the information processing apparatus 1000 through the network 3002 after encrypting the information output instruction.

The step S510 goes forward to the step S520, in which the information processing apparatus 1000 is operated to judge whether or not the information data signal received from the second information transmitting terminal 2002 includes the entry information element. When it is judged that the information data signal received from the second information transmitting terminal 2002 does not include the entry information element, the step S520 goes forward to the step S521, in which the information processing apparatus 1000 is operated to judge whether or not the information data signal received from the second information transmitting terminal 2002 includes the information output instruction after decrypting the information data signal. When it is judged that the information data signal received from the second information transmitting terminal 2002 includes the information output instruction, the step S521 goes forward to the step S560. When it is, on the other hand, judged that the information data signal received from the second information transmitting terminal 2002 does not include the information output instruction, the step S521 goes forward to the step S580, in which the information processing apparatus 1000 is operated to return “error” or “null” to the second information terminal 2002.

In the step S560, the information obtaining device 1400 is operated to transmit a decryption request signal to the encrypting and decrypting device 1500. The time confirming section 1500e of the encrypting and decrypting device 1500 is operated to judge whether or not the time currently kept by the standard time keeping device 1100 indicates time during the vote counting period in response to the decryption request signal transmitted from the information obtaining device 1400. When it is judged that the time currently kept by the standard time keeping device 1100 indicates time during the vote counting period, the step S560 goes forward to the step S571. When it is, on the other hand, judged that the time currently kept by the standard time keeping device 1100 does not indicate time during the vote counting period, the step S560 goes forward to the step S580, in which the information processing apparatus 1000 is operated to return “error” or “null” to the second information terminal 2002.

In the step S571, the information obtaining device 1400 is operated to transmit the information data signal to the encrypting and decrypting device 1500, and the encrypting and decrypting device 1500 is operated to analyze the received information, i.e., the information data signal including the information output instruction, and determine object data to be decrypted (see step S543).

The step S571 goes forward to the step S572, in which the encrypting and decrypting device 1500 is operated to obtain the object data to be decrypted from the data storing device 1600. The step S572 goes forward to the step S573, in which the encrypting and decrypting device 1500 is operated to decrypt the object data. The step S573 goes forward to the step S574, in which the decrypted data is returned to the second information transmitting terminal 2002 through the information obtaining device 1400 via the network 3002. The second information transmitting terminal 2002 is thus operated to output the decrypted data, i.e., the entry information elements to the election administrator. More specifically, the decrypted data, i.e., data indicative of the entry information elements are again encrypted by the information obtaining device 1400, and then transmitted to the second information transmitting terminal 2002 via the network 3002, and the second information transmitting terminal 2002 is operated to receive the decrypted data, i.e., the data indicative of the entry information elements after decrypting the encrypted data indicative of the entry information elements.

As will be seen from the foregoing description, it is to be understood that the information processing apparatus 1000 according to the present invention comprising an output period setting section 1500a of the encrypting and decrypting device 1500 for setting an output operation period, viz., vote counting period, after specifying a vote counting start time and a vote counting end time collectively defining the vote counting period; standard time keeping device 1100 for keeping time including the vote counting start time specified by the output period setting section 1500a and the vote counting end time specified by the output period setting section 1500a; information receiving device 1300 for receiving the entry information elements transmitted from the first information transmitting terminal 2001 via the network 3001; encrypting section 1500c of the encrypting and decrypting device 1500 for encrypting the entry information elements received from the information receiving device 1300 before producing encrypted entry information elements; data storing device 1600 for storing the encrypted entry information elements produced by the encrypting section 1500c; and decrypting section 1500d of the encrypting and decrypting device 1500 for decrypting the encrypted entry information elements stored in the data storing device 1600 during the vote counting period starting from the vote counting start time kept by the standard time keeping device 1100 until the vote counting end time kept by the standard time keeping device 1100, wherein the vote counting period wherein the vote counting period is kept secret, makes it impossible anyone including third party and internal personnel to collect entry information elements decrypted by the decrypting section 1500d during the vote counting period, thereby making it impossible for anyone including third party and internal personnel to tap or falsify the entry information elements decrypted by the decrypting section 1500d, thereby ensuring a protection of privacy and realizing a fair and impartial election.

Furthermore, the decrypted data is encrypted and transmitted to the second information transmitting terminal 2002 through the information obtaining device 1400 via the network 3002 only when it is judged that the time currently kept by the standard time keeping device 1100 indicates time during the vote counting period, which is kept secret, can prevent anyone including third party and internal personnel from collecting the encryption information from the entry information elements while being transmitted, thereby making it impossible for third parties to crack the encryption information and decrypt the encrypted entry information elements, and protecting privacy of electors. Preferably, any data sent and received within constituent elements of the information processing apparatus 1000 such as for example the standard time keeping device 1100, the time management device 1200, the information receiving device 1300, the information obtaining device 1400, the encrypting and decrypting device 1500, and the data storing device 1600 should be encrypted while being transmitted to enhance security.

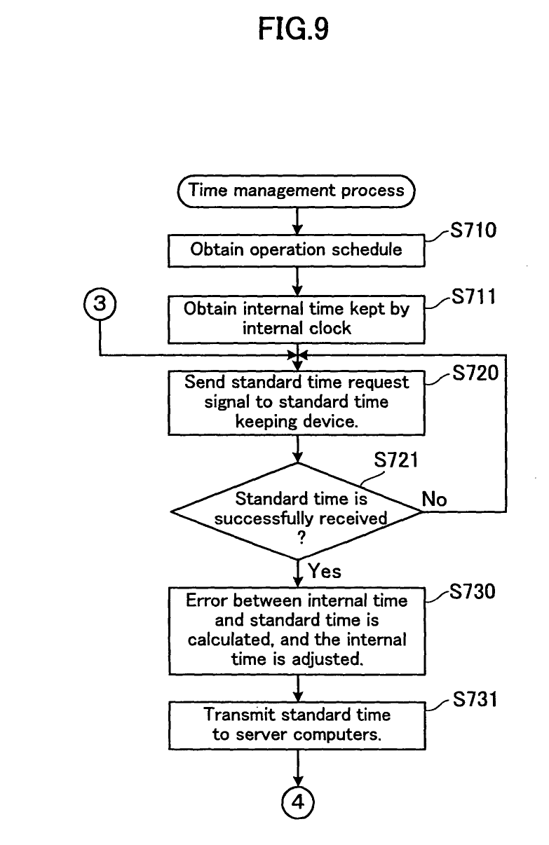

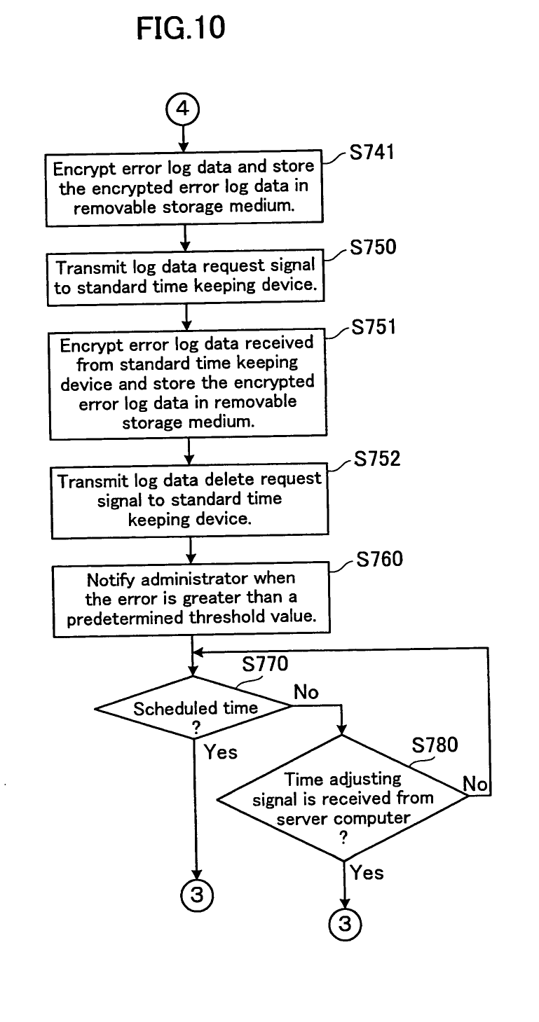

The following description will now be directed to the time management process to be performed by the time management device 1200 forming part of the first embodiment of the information processing apparatus according to the present invention with reference to the flowcharts shown in FIGS. 9 and 10.

In the step S710, the time management device 1200 is powered on. The time management device 1200 is operated to read and obtain the operation schedule from the removable storage medium (see step S410), and store the operation schedule into the storage portion of the time management device 1200 after encrypting the operation schedule. Preferably, the storage portion of the time management device 1200 should be a removable storage medium such as for example a disk.

The step S710 goes forward to the step S711, in which the time management device 1200 is operated to obtain internal time kept by the internal clock forming part of the time management device 1200.

The step S711 goes forward to the step S720, in which the time management device 1200 is operated to transmit a standard time request signal to the standard time keeping device 1100.

The step S720 goes forward to the step S721, in which the standard time keeping device 1100 is operated to transmit the time signal indicative of standard time to the time management device 1200 in response to the standard time request signal. The time management device 1200 is then operated to judge whether or not the standard time is successfully received from the standard time keeping device 1100. When it is judged that the standard time is successfully received, the step S721 goes forward to thee step S730. When it is, on the other hand, judged that the standard time is not successfully received, the step S721 goes back to the step S720.

In the step S730, the time management device 1200 is operated to calculate an error between the internal time obtained in the step S711 and the standard time obtained in the step S721 and adjust the internal clock forming part of the time management device 1200 to have the internal clocks forming part of the time management device 1200 synchronized to the standard time keeping device 1100. The time management device 1200 is then operated to produce error log data indicative of an error between the time thus adjusted and currently kept by the internal clock forming part of the time management device 1200 and the time previously kept by the internal clock forming part of the time management device 1200 before adjusted.

The step S730 goes forward to the step S731, in which the time management device 1200 is operated to transmit the time signal received in the step S721 to each of the server computers forming part of the information receiving device 1300, the information obtaining device 1400, the encrypting and decrypting device 1500, and the data storing device 1600, and adjust each of internal clocks forming parts of the information receiving device 1300, the information obtaining device 1400, the encrypting and decrypting device 1500, and the data storing device 1600 to have each of the internal clocks forming part of the time management device 1200, the information receiving device 1300, the information obtaining device 1400, the encrypting and decrypting device 1500, and the data storing device 1600 synchronized to the standard time keeping device 1100.

Here, the time management device 1200 may be operated to produce error log data indicative of an error between the time thus adjusted and currently kept by the internal clock forming part of the information receiving device 1300 and the time previously kept by the internal clock forming part of the information receiving device 1300 before adjusted, an error between the time thus adjusted and currently kept by the internal clock forming part of the information obtaining device 1400 and the time previously kept by the internal clock forming part of the information obtaining device 1400 before adjusted, an error between the time thus adjusted and currently kept by the internal clock forming part of the encrypting and decrypting device 1500 and the time previously kept by the internal clock forming part of the encrypting and decrypting device 1500 before adjusted, and an error between the time thus adjusted and currently kept by the internal clock forming part of the data storing device 1600 and the time previously kept by the internal clock forming part of the data storing device 1600 before adjusted.

The step S731 goes forward to the step S741, in which the time management device 1200 is operated to encrypt the error log data produced in the steps S730 and S731, and store the encrypted error log data into a removable storage medium.

The step S741 goes forward to the step S750, in which the time management device 1200 is operated to transmit a log data request signal to the standard time keeping device 1100.

The step S750 goes forward to the step S751, in which the standard time keeping device 1100 is operated to transmit the error log data indicative of the error between the time thus adjusted and currently kept by the internal clock forming part of the standard time keeping device 1100 and the time previously kept by the internal clock forming part of the standard time keeping device 1100 before adjusted to the time management device 1200. The time management device 1200 is operated to receive the error log data from the standard time keeping device 1100, and encrypt the error log data. The time management device 1200 is then operated to store the encrypted error log data in a removable storage medium such as for example a disk.

The step S751 goes forward to the step S752, in which the time management device 1200 is operated to transmit a log data delete request signal to the standard time keeping device 1100. The standard time keeping device 1100 is operated to delete the error log data in response to the log data delete request signal.

The step S752 goes forward to the step S760, in which the time management device 1200 is operated to judge whether or not the error between the time thus adjusted and currently kept by the internal clock forming part of the standard time keeping device 1100 and the time previously kept by the internal clock forming part of the standard time keeping device 1100 before adjusted is greater than a predetermined threshold value on the basis of the error log data. The time management device 1200 is operated to notify the administrator that the error occurred in the standard time keeping device 1100 when it is judged that the error is greater than a predetermined threshold value. The time management device 1200 is operated to judge whether or not the error between the time thus adjusted and currently kept by the internal clock forming part of the time management device 1200 and the time previously kept by the internal clock forming part of the time management device 1200 before adjusted is greater than a predetermined threshold value on the basis of the error log data. The time management device 1200 is operated to notify the administrator that the fault occurred in the time management device 1200 when it is judged that the error is greater than a predetermined threshold value. Similarly to the above, the time management device 1200 may be operated to judge whether or not any error occurred in each of the internal clocks forming part of the information receiving device 1300, the information obtaining device 1400, the encrypting and decrypting device 1500, and the data storing device 1600, and notify the administrator of the error when it is judged that any error occurred.

The step S760 goes forward to the step S770, in which the time management device 1200 is operated to judge whether or not it is a scheduled adjusting time on the basis of the operation schedule. When it is judged that it is the scheduled adjusting time, the step S770 goes back to the step S720. When it is, on the other hand, judged that it is not the scheduled adjusting time, the step S770 goes forward to the step S780. In the step S780, it is judged whether or not the time adjusting signal is received from any one of server computers forming part of the information receiving device 1300, the information obtaining device 1400, the encrypting and decrypting device 1500, and the data storing device 1600, and adjust each of internal clocks forming parts of the information receiving device 1300. When it is judged that the time adjusting signal is received, the step S770 goes back to the step S720. When it is, on the other hand, judged that the time adjusting signal is not received, the step S770 goes back to the step S770.

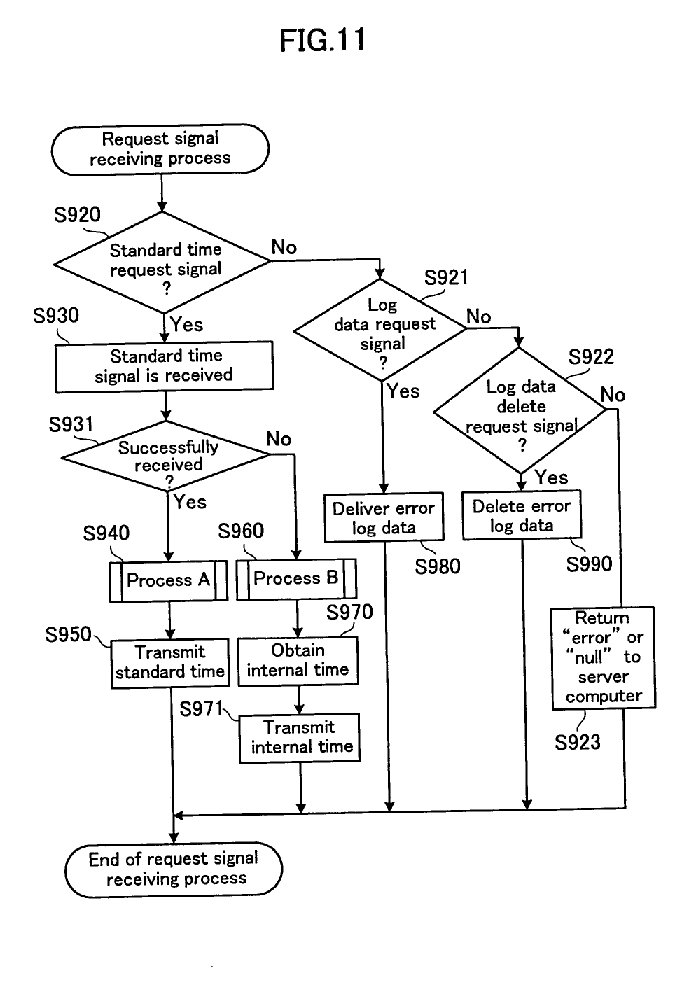

The following description will be directed to the request signal receiving process to be performed by the standard time keeping device 1100 with reference to the flow chart shown in FIG. 11.

In the step S920, the standard time keeping device 1100 is operated to receive a request signal from a server computer. The standard time keeping device 1100 is operated to judge whether or not the request signal is the standard time request signal.

When it is judged that the request signal is the standard time request signal, the step S920 goes forward to the step S930. When it is, on the other hand, judged that the request signal is not the standard time request signal, the step S920 goes forward to the step S921.

In the step S930, the standard time keeping device 1100 is operated to receive the standard time signal indicative of standard time from the standard time provider at a predetermined frequency. The step S930 goes forward to the step S931, in which it is judged whether or not the standard time signal indicative of standard time is successfully received. When it is judged that the standard time signal indicative of standard time is successfully received, the step S931 goes forward to the step S940, in which the process A in the step S320 is performed (see FIG. 5). When it is, on the other hand, judged that the standard time signal indicative of standard time is not successfully received, the step S931 goes forward to the step S960, in which the process B in the step S340 is performed (see FIG. 5).

The step S940 goes forward to the step S950, in which the standard time keeping device 1100 is operated to transmit a time signal indicative of time signal indicative of standard time transmitted by the standard time provider to the server computer. The step S960 goes forward to the step S970, in which the standard time keeping device 1100 is operated to obtain time kept by the time keeping section 1100a of time keeping device 1100. The step S970 goes forward to the step S971, in which the standard time keeping device 1100 is operated to transmit a time signal indicative of time kept by the time keeping device 1100 and a notice signal notifying that the time signal is indicative of time kept by the time keeping device 1100 to the server computer.

In the step S921, the standard time keeping device 1100 is operated to judge whether or not the request signal is the log data request signal. When it is judged that the request signal is the log data request signal, the step S921 goes forward to the step S980, in which the standard time keeping device 1100 is operated to transmit the error log data to the server computer. When it is, on the other hand, judged that the request signal is not the log data request signal, the step S921 goes forward to the step S922.

In the step S922, the standard time keeping device 1100 is operated to judge whether or not the request signal is the log data delete request signal. When it is judged that the request signal is the log data delete request signal, the step S922 goes forward to the step S990, in which the standard time keeping device 1100 is operated to delete the error log data. When it is, on the other hand, judged that the request signal is not the log data delete request signal, the step S922 goes forward to the step S923, in which the standard time keeping device 1100 is operated to return “error” or “null” to the server computer.

As will be seen from the foregoing description, it is to be understood that the first embodiment of the information processing apparatus 1000 according to the present invention, comprising a time obtaining section 1100b of the standard time keeping device 1100 for obtaining standard time information indicative of standard time kept by a standard clock; and a time adjusting section 1100c for adjusting the internal clock of the standard time keeping device 1100 to have the internal clock of the standard time keeping device 1100 synchronized to the standard time on the basis of the standard time information obtained by the time obtaining section 1100b, makes it possible for internal clocks forming part of constituents elements of the information processing apparatus to be accurately synchronized to one another, thereby enabling to realize a fair and impartial election.

From the foregoing description, it is to be understood that the information processing apparatus 1000 according to the present invention comprising the input period setting section 1500b of the encrypting and decrypting device 1500 for setting an input operation period, viz., the voting period, after specifying the vote start time and the vote end time collectively defining the voting period, and the standard time keeping device 1100 is operative to keep time including the vote start time specified by the input period setting section 1500b and the vote end time specified by the input period setting section 1500b, and the information receiving device 1300 is operative to receive the voting information elements transmitted from first information transmitting terminal 2001 via the network 3001 during the voting period starting from the vote start time kept by the standard time keeping device 1100 until the vote end time kept by the standard time keeping device 1100, wherein the voting period is kept secret, makes it impossible anyone including third party and internal personnel to collect the entry information elements while being transmitted through the network 3001 in the voting period, thereby making it impossible for third parties to crack the encryption information and decrypt the encrypted entry information elements, and protecting privacy of electors. Furthermore, the information processing apparatus 1000 according to the present invention makes it impossible for anyone including third party and internal personnel to tap or falsify the entry information elements stored in data storing device 1600 thereby ensuring a fair and impartial election and a protection of privacy.

Furthermore, the information processing apparatus 1000 according to the present invention comprising an output period setting section 1500a of the encrypting and decrypting device 1500 for setting an output operation period, viz., vote counting period, after specifying a vote counting start time and a vote counting end time collectively defining the vote counting period; standard time keeping device 1100 for keeping time including the vote counting start time specified by the output period setting section 1500a and the vote counting end time specified by the output period setting section 1500a; information receiving device 1300 for receiving the entry information elements transmitted from the first information transmitting terminal 2001 via the network 3001; encrypting section 1500c of the encrypting and decrypting device 1500 for encrypting the entry information elements received from the information receiving device 1300 before producing encrypted entry information elements; data storing device 1600 for storing the encrypted entry information elements produced by the encrypting section 1500c; and decrypting section 1500d of the encrypting and decrypting device 1500 for decrypting the encrypted entry information elements stored in the data storing device 1600 during the vote counting period starting from the vote counting start time kept by the standard time keeping device 1100 until the vote counting end time kept by the standard time keeping device 1100, wherein the vote counting period wherein the vote counting period is kept secret, makes it impossible anyone including third party and internal personnel to collect entry information elements decrypted by the decrypting section 1500d during the vote counting period, thereby making it impossible for anyone including third party and internal personnel to tap or falsify the entry information elements decrypted by the decrypting section 1500d, thereby ensuring a protection of privacy and realizing a fair and impartial election.

Although there has been described in the above about the first embodiment of the information processing apparatus according to the present invention, this embodiment may be replaced by the second and third embodiments of the information processing system according to the present invention in order to attain the objects of the present invention. The second and third embodiments of the information processing system will then be described hereinlater.

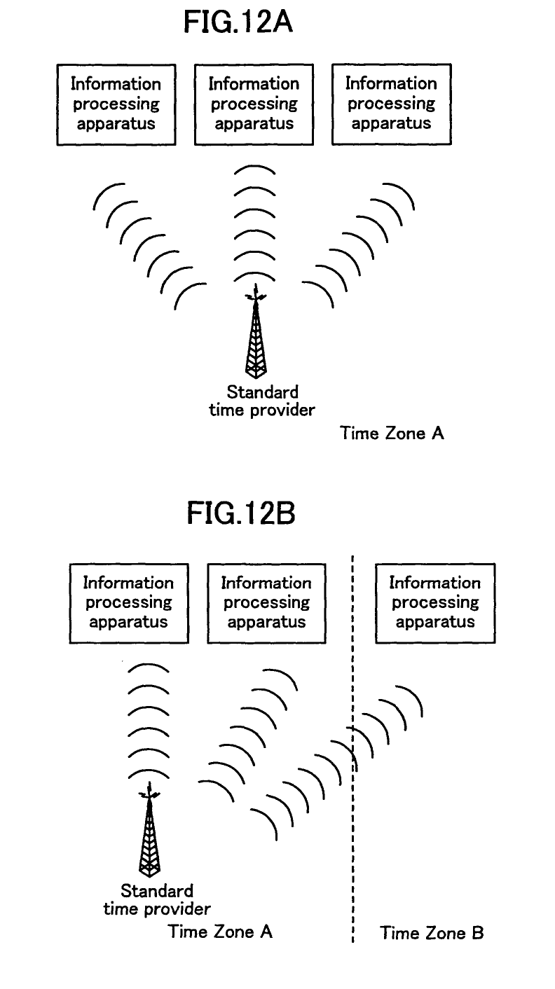

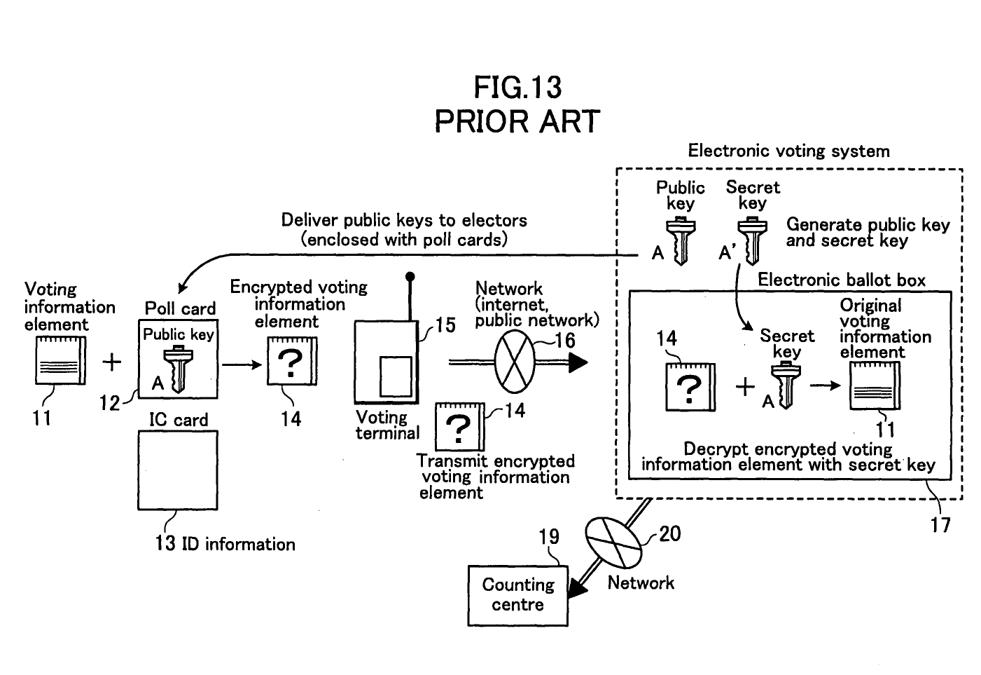

The second embodiment of the information processing system according to the present invention comprises a plurality of information processing apparatuses as shown in FIG. 12A. The constitutional elements and steps of each of the information processing apparatuses are entirely the same as those of the first embodiment of the information processing apparatus 1000 according to the present invention as shown in FIGS. 1 to 11 except for the constitutional elements and the steps appearing in the following description. Therefore, only the constitutional elements and the steps of the second to third embodiments of the information processing system different from those of the first embodiment of the information processing apparatus will be described in detail hereinlater. The constitutional elements and the steps of the second and third embodiments of the information processing system entirely the same as those of the first embodiment of the information processing apparatus will not be described but bear the same reference numerals and legends as those of the first embodiment of the information processing apparatus in FIG. 1 to avoid tedious repetition.

The constitutional elements of each of the information processing apparatuses constituting the second embodiment of the information processing system according to the present invention are the same as those of the first embodiment of the information processing apparatus 1000 according to the present invention, however, the information processing apparatuses constituting the second embodiment of the information processing system are located remotely spaced apart from one another in the same time zone A as shown in FIG. 12A.

In the second embodiment of the information processing system according to the present invention, the time obtaining section 1100b of the standard time keeping device 1100 of each of the information processing apparatuses is operative to obtain the standard time information indicative of standard time kept by the standard clock in the time zone A to ensure that the time keeping device 1100 of each of the information processing apparatuses is accurately synchronized to the standard time in the time zone A on the basis of the standard time information obtained by the time obtaining section 1100b of the time keeping device 1100 although the information processing apparatus constituting the second embodiment of the information processing system according to the present invention are located remotely spaced apart from one another, thereby enabling to realize a fair and impartial election.

From the foregoing description, it is to be understood that the second embodiment of the information processing system according to the present invention, comprising a plurality of information processing apparatuses, in which the time the time obtaining section 1100b of the standard time keeping device 1100 of each of the information processing apparatuses is operative to obtain the standard time information indicative of standard time kept by the standard clock in the time zone A to ensure that the time keeping device 1100 of each of the information processing apparatuses is accurately synchronized to the standard time in the time zone A on the basis of the standard time information obtained by the time obtaining section 1100b of the time keeping device 1100 although the information processing apparatus constituting the second embodiment of the information processing system according to the present invention are located remotely spaced apart from one another, thereby enabling to realize a fair and impartial election.

The following description will be directed to the constitutional elements and the steps of the third embodiment of the information processing system different from those of the second embodiment of the information processing system.

The third embodiment of the information processing system according to the present invention comprises a plurality of information processing apparatuses. The information processing apparatuses collectively forming part of the third embodiment of the information processing system are located remotely spaced apart from one another across time zones as shown in FIG. 12B. This means that one information processing apparatus may be placed in one time zone B while the standard time provider is located in other time zone B.

In the third embodiment of the information processing system according to the present invention, the standard time keeping device 1100 of each of the information processing apparatuses collectively forming part of the third embodiment of the information processing system further includes a position obtaining section 1100f for obtaining position information indicative of a position thereof. The time adjusting section 1100c of the standard time keeping device 1100 of each of the information processing apparatuses collectively forming part of the third embodiment of the information processing system is operative to adjust the time keeping section 1100a of each of the information processing apparatuses collectively forming part of the third embodiment of the information processing system to have the time keeping section 1100a synchronized to the standard time on the basis of the position information obtained by the position obtaining section 1100f.

This means that the position obtaining section 1100f of the standard time keeping device 1100 of each of the information processing apparatuses is operative to obtain position information indicative of an area where the information processing apparatus is placed. The time adjusting section 1100c is operative to determine a time zone B of the area where the information processing apparatus is placed, calculate a time difference between the time zone A where the time keeping section 1100a of the standard time keeping device 1100 is operative to obtain the standard time information indicative of standard time, and the time zone B where the information processing apparatus is placed, and adjust the time keeping section 1100a to have the time keeping section 1100a synchronized to local standard time in the time zone B of the area where the information processing apparatus is placed on the basis of the position information obtained by the position obtaining section 1100f. Here, the local standard time is intended to mean standard time in the time zone B where the information processing apparatus is placed and the electors input the voting information elements. The position obtaining section 1100f may be operative to obtain position information indicative of a position and area of the information processing apparatus on the basis of outputs of a self-contained sensor system such as for example a GPS (Global Positioning System). Here, the position information should be indicative of at least the longitude of the position where the information processing apparatus is located. Preferably, the position information should be indicative of the longitude and latitude of the position where the information processing apparatus is located so that the time adjusting section 1100c can accurately determine a time zone B of the area where the information processing apparatus is placed.

Furthermore, the information processing apparatus according to the present invention may have the time management device 1200 calculate the local standard time in accordance with the standard time information obtained by the time obtaining section 1100b in consideration of a time difference between the time zone B where the time keeping section 1100a of the standard time keeping device 1100 is operative to obtain the standard time information indicative of standard time, and the time zone B where the information processing apparatus is placed, and adjust the sever computers forming parts of the constituent elements of the information processing apparatus to have the internal clocks of the server computers synchronized to local standard time in the time zone B of the area where the information processing apparatus is placed on the basis of the position information obtained by the position obtaining section 1100f in lieu of the time adjusting section 1100c of the standard time keeping device 1100.

As will be seen from the foregoing description that the information processing apparatus according to the present invention comprising position obtaining section 1100f for obtaining position information indicative of a position thereof, in which the time management device 1200 is operative to adjust the sever computers forming parts of the constituent elements of the information processing apparatus to have the internal clocks of the server computers synchronized to local standard time in the time zone B of the area where the information processing apparatus is placed on the basis of the position information obtained by the position obtaining section 1100f, makes it possible for internal clocks forming part of constituents elements of the information processing apparatus to be accurately synchronized to one another, though the information processing apparatus may be placed in one time zone B different from the time zone A while the standard clock is located, thereby enabling to realize a fair and impartial election.

Although there has been described in the above about the information processing apparatus according to the present invention that the standard time keeping device 1100 of each of the information processing apparatuses collectively forming part of the third embodiment of the information processing system further includes a position obtaining section 1100f for obtaining position information indicative of a position thereof, the information processing apparatus may comprise no position obtaining section 1100f. Alternatively, the information processing apparatus may have a second operator input therein a time zone information indicative of the time zone B of the area where the information processing apparatus is placed, calculate a time difference between the time zone A where the time keeping section 1100a of the standard time keeping device 1100 is operative to obtain the standard time information indicative of standard time, and the time zone B where the information processing apparatus is placed, and adjust the sever computers forming parts of the constituent elements of the information processing apparatus to have the internal clocks of the server computers synchronized to local standard time in the time zone B of the area where the information processing apparatus is placed in response to the time zone information inputted by the second operator. Here, the local standard time is intended to mean standard time in the time zone B where the electors input the voting information elements.

The following description will be directed to the initializing process to be performed by the information processing apparatus according to the present invention with reference to FIG. 6.

In the step S412, the second conditions such as a location of the information processing apparatus 1000, server computers forming part of the information processing apparatus 1000, and the like are inputted. The second operator input therein time zone information indicative of the time zone B of the area where the information processing apparatus is placed as the location of the information processing apparatus 1000. The time adjusting section 1100c is operated to adjust the time keeping section 1100a to have the time keeping section 1100a synchronized to local standard time in the time zone B of the area where the information processing apparatus is placed in response to the time zone information inputted by the second operator.

Although there has been described in the above about the information processing apparatus that the time adjusting section 1100c is operated to adjust the time keeping section 1100a to have the time keeping section 1100a synchronized to local standard time in the time zone B of the area where the information processing apparatus is placed in response to the time zone information inputted by the second operator, the time adjusting section 1100c may not be operated to adjust the time keeping section 1100a to have the time keeping section 1100a synchronized to local standard time in the time zone B of the area where the information processing apparatus is placed in response to the time zone information. Alternatively, the information processing apparatus may have the time management device 1200 calculate the local standard time in accordance with the standard time information obtained by the time obtaining section 1100b in consideration of a time difference between the time zone B where the time keeping section 1100a of the standard time keeping device 1100 is operative to obtain the standard time information indicative of standard time, and the time zone B where the information processing apparatus is placed.

The following description will be directed to the time management process to be performed by the information processing apparatus according to the present invention with reference to FIG. 9.

In the step S721, the standard time keeping device 1100 is operated to transmit the time signal indicative of standard time to the time management device 1200 in response to the standard time request signal. The time management device 1200 is then operated to judge whether or not the standard time is successfully received from the standard time keeping device 1100. When it is judged that the standard time is successfully received, the time management device 1200 is operated to calculate the local standard time in accordance with the standard time information obtained by the standard time keeping device 1100 in consideration of a time difference between the time zone A where the time keeping section 1100a of the standard time keeping device 1100 is operative to obtain the standard time information indicative of standard time, and the time zone B where the information processing apparatus is placed.

In the step S730, the time management device 1200 is operated to calculate an error between the internal time obtained in the step S711 and the local standard time obtained in the step S721 and adjust the internal clock forming part of the time management device 1200 to have the internal clocks forming part of the time management device 1200 synchronized to the local standard time calculated in the step S721. In the step S731, the time management device 1200 is operated to transmit the time signal indicative of the local standard time calculated in the step S721 to each of the server computers forming part of the information receiving device 1300, the information obtaining device 1400, the encrypting and decrypting device 1500, and the data storing device 1600, and adjust each of internal clocks forming parts of the information receiving device 1300, the information obtaining device 1400, the encrypting and decrypting device 1500, and the data storing device 1600 to have each of the internal clocks forming part of the time management device 1200, the information receiving device 1300, the information obtaining device 1400, the encrypting and decrypting device 1500, and the data storing device 1600 synchronized to the local standard time calculated in the step S721.

As will be seen from the foregoing description, in the information processing apparatus according to the present invention, comprising a plurality of information processing apparatuses located remotely spaced apart from one another across time zones, internal clocks forming part of constituents elements of the information processing apparatus can be accurately synchronized to one another, though one information processing apparatus may be placed in one time zone while the standard time provider is located in other time zone, thereby enabling to realize a fair and impartial election.

Though there has been described in the foregoing embodiments that the time the standard time keeping device 1100 is operative to receive time signals indicative of standard time from the standard time provider via radio at a predetermined frequency, the standard time keeping device 1100 forming part of the information processing apparatus according to the present invention may be operative to receive time signals indicative of standard time from the standard time provider through a public network such as for example internet.

While the subject invention has been described with relation to the embodiments, various modifications and adaptations thereof will now be apparent to those skilled in the art as far as such modifications and adaptations fall within the scope of the appended claims intended to be covered thereby.

What is claimed is:

1. An information processing apparatus for processing a plurality of entry information elements transmitted from at least one terminal, comprising:
period setting means for setting an output operation period after specifying an output start time and an output end time collectively defining said output operation period;
time keeping means for keeping time including said output start time specified by said period setting means and said output end time specified by said period setting means;
information receiving means for receiving said entry information elements transmitted from said terminal;
information encrypting means for encrypting said entry information elements received from said information receiving means before producing encrypted entry information elements;
information storing means for storing said encrypted entry information elements produced by said information encrypting means; and
information decrypting means for decrypting said encrypted entry information elements stored in said information storing means during said output operation period starting from said output start time kept by said time keeping means until said output end time kept by said time keeping means.

2. An information processing apparatus as set forth in claim 1, which further comprises:
time obtaining means for obtaining standard time information indicative of standard time kept by a standard clock; and
time adjusting means for adjusting said time keeping means to have said time keeping means synchronized to said standard time on the basis of said standard time information obtained by said time obtaining means.

3. An information processing apparatus as set forth in claim 2, in which said time obtaining means includes a standard time receiver for receiving said standard time information transmitted from a standard time transmitter at a predetermined frequency.

4. An information processing apparatus as set forth in claim 3, in which said standard time receiver is of a waterproof and heat resistant construction.

5. An information processing apparatus as set forth in claim 2, which further comprises: error storing means for storing error information indicative of an error of said time kept by said time keeping means with respect to said standard time on the bass of said standard time information obtained by said time obtaining means.

6. An information processing apparatus as set forth in claim 2, which further comprises:
position obtaining means for obtaining position information indicative of a position thereof, in which said time adjusting means is operative to adjust said time keeping means to have said time keeping means synchronized to said standard time on the basis of said position information obtained by said position obtaining means.

7. An information processing apparatus as set forth in claim 2, which
said time obtaining means is placed in a first time zone while said terminal is placed in a second time zone different from said first time zone,
said period setting means, said information receiving means, and said information storing means have respective internal clocks,
said time adjusting means is operative to calculate alternative standard time in accordance with said standard time information obtained by said time obtaining means in consideration of a time difference between said first time zone where said time obtaining means is operative to obtain said standard time information indicative of standard time, and said second time zone where said terminal is placed, and adjust each of said internal clocks forming part of said period setting means, said information receiving means, and said information storing means to have each of said period setting means, said information receiving means, and said information storing means synchronized to said alternative standard time thus calculated.

8. An information processing apparatus as set forth in claim 1, in which
said period setting means is operative to set an input operation period after specifying an input start time and an input end time collectively defining said input operation period, and said time keeping means is operative to keep time including said input start time specified by said period setting means and said input end time specified by said period setting means, and
said information receiving means is operative to receive said entry information elements transmitted from said terminal during said input operation period starting from said input start time kept by said time keeping means until said input end time kept by said time keeping means.

9. An information processing apparatus as set forth in claim 1, which further comprises:
instruction accepting means for accepting an output instruction from said terminal, and in which
said information decrypting means is operative to decrypt said encrypted entry information elements stored in said information storing means in response to said output instruction accepted by said instruction accepting means during said output operation period starting from said output start time kept by said time keeping means until said output end time kept by said time keeping means.

10. An information processing apparatus as set forth in claim 1, in which
each of said entry information elements is indicative of voting information elements.

11. An information processing apparatus as set forth in claim 1, in which
each of said entry information elements is indicative of biding information elements.

12. An information processing system comprising a plurality of information processing apparatuses for processing a plurality of entry information elements transmitted from at least one terminal,
said information processing apparatuses each comprising:
period setting means for setting an output operation period after specifying an output start time and an output end time collectively defining said output operation period;
time keeping means for keeping time including said output start time specified by said period setting means and said output end time specified by said period setting means;
information receiving means for receiving said entry information elements transmitted from said terminal;
information encrypting means for encrypting said entry information elements received from said information receiving means before producing encrypted entry information elements;
information storing means for storing said encrypted entry information elements produced by said information encrypting means;
information decrypting means for decrypting said encrypted entry information elements stored in said information storing means during said output operation period starting from said output start time kept by said time keeping means until said output end time kept by said time keeping means;
time obtaining means for obtaining standard time information indicative of standard time kept by a standard clock; and
time adjusting means for adjusting said time keeping means to have said time keeping means synchronized to said standard time on the basis of said standard time information obtained by said time obtaining means; whereby
said time obtaining means of each of said information processing apparatuses is operative to obtain said standard time information indicative of standard time kept by the standard clock to ensure that said time keeping means of each of said information processing apparatuses is synchronized to said standard time on the basis of said standard time information obtained by said time obtaining means.

13. An information processing method of processing a plurality of entry information elements transmitted from at least one terminal, comprising the steps of:
(a) setting an output operation period after specifying an output start time and an output end time collectively defining said output operation period;
(b) keeping time including said output start time specified in said step (a) and said output end time specified in said step (a);
(c) receiving said entry information elements transmitted from said terminal;
(d) encrypting said entry information elements received in said step (c) before producing encrypted entry information elements;
(e) storing said encrypted entry information elements produced in said step (d) in a predetermined storage portion; and
(f) decrypting said encrypted entry information elements stored in said step (e) during said output operation period starting from said output start time kept in said step (b) until said output end time kept in said step (b).

14. An information processing method as set forth in claim 13, which further comprises the steps of:
(g) obtaining standard time information indicative of standard time kept by a standard clock; and
(h) adjusting said step (b) to have said time kept in said step (b) synchronized to said standard time on the basis of said standard time information obtained in said step (g).

15. An information processing method as set forth in claim 14, in which said step (g) has the step of having a standard time receiver receive said standard time information transmitted from a standard time transmitter at a predetermined frequency.

16. An information processing method as set forth in claim 15, in which said standard time receiver is of a waterproof and heat resistant construction.

17. An information processing method as set forth in claim 14, which further comprises the step of: (i) storing error information indicative of an error of said time kept in said step (b) with respect to said standard time on the bass of said standard time information obtained in said step (g) in a removable storage portion.

18. An information processing method as set forth in claim 14, which further comprises the step of:
(j) obtaining position information indicative of a position thereof, in which said step (h) has the step of adjusting said step (b) to have said time kept in said step (b) synchronized to said standard time on the basis of said position information obtained in said step (j).

19. An information processing method as set forth in claim 14, which
said standard clock is placed in a first time zone while said terminal is placed in a second time zone different from said first time zone,
said step (a), said step (c), and said step (e) are performed in accordance with respective internal clocks,
said step (h) has the step of calculating alternative standard time in accordance with said standard time information obtained in said step (g) in consideration of a time difference between said first time zone where said standard clock is placed and said second time zone where said terminal is placed, and adjusting each of said internal clocks to have each of said step (a), said step (c), and said step (e) performed in synchronization with said alternative standard time thus calculated.

20. An information processing method as set forth in claim 13, in which
said step (a) has the step of (a1) setting an input operation period after specifying an input start time and an input end time collectively defining said input operation period, and said step (b) has the step of keeping time including said input start time specified in said step (a1) and said input end time specified in said step (a1), and
said step (c) has the step of receiving said entry information elements transmitted from said terminal during said input operation period starting from said input start time kept in said step (b) until said input end time kept in said step (b).

21. An information processing method as set forth in claim 13, which further comprises the step of:
(k) accepting an output instruction from said terminal, and in which
said step (f) has the step of decrypting said encrypted entry information elements stored in said step (e) in response to said output instruction accepted in said step (k) during said output operation period starting from said output start time kept in said step (b) until said output end time kept in said step (b).

22. An information processing method as set forth in claim 13, in which
each of said entry information elements is indicative of voting information elements.

23. An information processing method as set forth in claim 13, in which
each of said entry information elements is indicative of biding information elements.

24. An information processing method of processing a plurality of entry information elements transmitted from at least one terminal, comprising:
a preparing step of preparing a plurality of a plurality of information processing apparatuses, each of said information processing apparatuses comprising: period setting means for setting an output operation period after specifying an output start time and an output end time collectively defining said output operation period; time keeping means for keeping time including said output start time specified by said period setting means and said output end time specified by said period setting means; information receiving means for receiving said entry information elements transmitted from said terminal; information encrypting means for encrypting said entry information elements received from said information receiving means before producing encrypted entry information elements; information storing means for storing said encrypted entry information elements produced by said information encrypting means; information decrypting means for decrypting said encrypted entry information elements stored in said information storing means during said output operation period starting from said output start time kept by said time keeping means until said output end time kept by said time keeping means; time obtaining means for obtaining standard time information indicative of standard time kept by a standard clock; and time adjusting means for adjusting said time keeping means to have said time keeping means synchronized to said standard time on the basis of said standard time information obtained by said time obtaining means, and
a time obtaining step of having said time obtaining means of each of said information processing apparatuses obtain said standard time information indicative of standard time kept by the standard clock to ensure that said time keeping means of each of said information processing apparatuses is synchronized to said standard time on the basis of said standard time information obtained by said time obtaining means.

25. An information processing computer program product comprising a computer usable storage medium having computer readable code embodied therein for processing a plurality of entry information elements transmitted from at least one terminal, wherein said computer readable code comprising:
a first program product code for setting an output operation period after specifying an output start time and an output end time collectively defining said output operation period;
a second program product code for keeping time including said output start time specified by said first program product code and said output end time specified by said first program product code;
a third program product code for receiving said entry information elements transmitted from said terminal;
a fourth program product code for encrypting said entry information elements received by said third program product code before producing encrypted entry information elements;
a fifth program product code for storing said encrypted entry information elements produced by said fourth program product code in a predetermined storage portion; and
a sixth program product code for decrypting said encrypted entry information elements stored by said fifth program product code during said output operation period starting from said output start time kept by said second program product code until said output end time kept by said second program product code.

26. An information processing computer program product as set forth in claim 25, which further comprises:
a seventh program product code for obtaining standard time information indicative of standard time kept by a standard clock; and
an eighth program product code for adjusting said second program product code to have said time kept by said second program product code synchronized to said standard time on the basis of said standard time information obtained by said seventh program product code.

27. An information processing computer program product as set forth in claim 26, in which said seventh program product code has a program product code for having a standard time receiver receive said standard time information transmitted from a standard time transmitter at a predetermined frequency.

28. An information processing computer program product as set forth in claim 27, in which said standard time receiver is of a waterproof and heat resistant construction.

29. An information processing computer program product as set forth in claim 26, which further comprises a ninth program product code for storing error information indicative of an error of said time kept by said second program product code with respect to said standard time on the bass of said standard time information obtained by said seventh program product code in a removable storage portion.

30. An information processing computer program product as set forth in claim 26, which further comprises:
a tenth program product code for obtaining position information indicative of a position thereof, in which said eighth program product code has a program product code for adjusting said second program product code to have said time kept by said second program product code synchronized to said standard time on the basis of said position information obtained by said tenth program product code.

31. An information processing computer program product as set forth in claim 26, which
said standard clock is placed in a first time zone while said terminal is placed in a second time zone different from said first time zone,
said first program product code, said third program product code, and said fifth program product code are performed in accordance with respective internal clocks,
said eighth program product code has a program product code for calculating alternative standard time in accordance with said standard time information obtained by said seventh program product code in consideration of a time difference between said first time zone where said standard clock is placed and said second time zone where said terminal is placed, and adjusting each of said internal clocks to have each of said first program product code, said third program product code, and said fifth program product code performed in synchronization with said alternative standard time thus calculated.

32. An information processing computer program product as set forth in claim 25, in which
said first program product code has a twelfth program product code for setting an input operation period after specifying an input start time and an input end time collectively defining said input operation period, and said second program product code has a program product code for keeping time including said input start time specified by said twelfth program product code and said input end time specified by said twelfth program product code, and
said third program product code has a program product code for receiving said entry information elements transmitted from said terminal during said input operation period starting from said input start time kept by said second program product code until said input end time kept by said second program product code.

33. An information processing computer program product as set forth in claim 25, which further comprises:
an eleventh program product code for accepting an output instruction from said terminal, and in which
said sixth program product code has a program product code for decrypting said encrypted entry information elements stored by said fifth program product code in response to said output instruction accepted by said eleventh program product code during said output operation period starting from said output start time kept by said second program product code until said output end time kept by said second program product code.

34. An information processing computer program product as set forth in claim 25, in which
each of said entry information elements is indicative of voting information elements.

35. An information processing computer program product as set forth in claim 25, in which
each of said entry information elements is indicative of biding information elements.

36. An information processing computer program product comprising a computer usable storage medium having computer readable code embodied therein for processing a plurality of entry information elements transmitted from at least one terminal, wherein said computer readable code comprising:
a fifteenth program product code for operating a plurality of a plurality of information processing apparatuses, each of said information processing apparatuses comprising: period setting means for setting an output operation period after specifying an output start time and an output end time collectively defining said output operation period; time keeping means for keeping time including said output start time specified by said period setting means and said output end time specified by said period setting means; information receiving means for receiving said entry information elements transmitted from said terminal; information encrypting means for encrypting said entry information elements received from said information receiving means before producing encrypted entry information elements; information storing means for storing said encrypted entry information elements produced by said information encrypting means; information decrypting means for decrypting said encrypted entry information elements stored in said information storing means during said output operation period starting from said output start time kept by said time keeping means until said output end time kept by said time keeping means; time obtaining means for obtaining standard time information indicative of standard time kept by a standard clock; and time adjusting means for adjusting said time keeping means to have said time keeping means synchronized to said standard time on the basis of said standard time information obtained by said time obtaining means, and
a sixteenth program product code for having said time obtaining means of each of said information processing apparatuses obtain said standard time information indicative of standard time kept by the standard clock to ensure that said time keeping means of each of said information processing apparatuses is synchronized to said standard time on the basis of said standard time information obtained by said time obtaining means.

37. An information processing apparatus as set forth in claim 1, in which said output operation period is kept secret.

38. An information processing apparatus as set forth in claim 8, in which said input operation period is kept secret.
